(19) United States
(12) Patent Application Publication
(10) Pub. No.: US 2013/0050666 A1
(43) Pub. Date: Feb. 28, 2013

(54) EXPOSURE APPARATUS, LIQUID HOLDING METHOD, AND DEVICE MANUFACTURING METHOD

(71) Applicant: Hiroyuki NAGASAKA, Kumagaya-shi (JP)

(72) Inventor: Hiroyuki NAGASAKA, Kumagaya-shi (JP)

(73) Assignee: NIKON CORPORATION, Tokyo (JP)

(21) Appl. No.: 13/593,005

(22) Filed: Aug. 23, 2012

Related U.S. Application Data
(60) Provisional application No. 61/530,055, filed on Sep. 1, 2011.

(30) Foreign Application Priority Data
Aug. 26, 2011 (JP) 2011-184549
Jul. 9, 2012 (JP) 2012-154072

(51) Int. Cl. G03B 27/52

(52) U.S. Cl. 355/30; 355/77

(57) ABSTRACT

An exposure apparatus exposes a substrate to exposure light through liquid. The exposure apparatus includes: a first member which is disposed in at least a portion of the periphery of a light path of the exposure light, and has a first surface that faces an upper surface of an object via a first gap interposed therebetween and holds the liquid between the upper surface of the object and the first surface; a second member which is disposed at the outside of the first surface with respect to the light path, and has a second surface that faces the upper surface of the object via a second gap interposed therebetween; and a suction port which is disposed between the first surface and the second surface, and suctions at least a portion of gas in a space located outside the second member with respect to the light path, through the second gap.

### CROSS-REFERENCE TO RELATED APPLICATION

This application is a non-provisional application claiming priority to and the benefit of U.S. Provisional Application No. 61/530,055, filed Sep. 1, 2011, and is claiming priority to Japanese Patent Application No. 2011-184549, filed on Aug. 26, 2011, and Japanese Patent Application No. 2012-154072, filed on Jul. 9, 2012. The entire contents of which are incorporated herein by reference.

### BACKGROUND

1. Field of the Invention

The present invention relates to an exposure apparatus, a liquid holding method, and a device manufacturing method.

2. Description of Related Art

In exposure apparatuses used for a photolithography process, a liquid immersion exposure apparatus that exposes a substrate to exposure light through liquid is known, for example, as disclosed in Specification of U.S. Patent Application Publication No. 2009/0,046,261.

### SUMMARY

In a liquid immersion exposure apparatus, for example, when liquid flows out from a predetermined space, there is a possibility of a defective exposure being generated. As a result, there is a possibility of a defective device being generated.

An object of aspects according to the present invention is to provide an exposure apparatus and a liquid holding method which are capable of suppressing the generation of a defective exposure. In addition, another object of the aspects according to the present invention is to provide a device manufacturing method which is capable of suppressing the generation of a defective device.

An exposure apparatus according to an aspect of the present invention that exposes a substrate to exposure light through liquid, includes: a first member which is disposed in at least a portion of the periphery of a light path of the exposure light, and has a first surface that faces an upper surface of an object via a first gap interposed therebetween and holds the liquid between the upper surface of the object and the first surface; a second member which is disposed at the outside of the first surface with respect to the light path, and has a second surface that faces the upper surface of the object via a second gap interposed therebetween; and a suction port which is disposed between the first surface and the second surface, and suctions at least a portion of gas in a space located outside the second member with respect to the light path, through the second gap, wherein the size of the second gap is smaller than the size of the first gap.

An exposure apparatus according to an aspect of the present invention that exposes a substrate to exposure light through liquid, includes: a first member which is disposed in at least a portion of the periphery of a light path of the exposure light, and has a first surface that faces an upper surface of an object via a first gap interposed therebetween and holds the liquid between the upper surface of the object and the first surface; a second member which is disposed at the outside of the first surface with respect to the light path, and has a second surface that faces the upper surface of the object via a second gap interposed therebetween; a chamber device having an environmental control unit that supplies first gas to an internal space in which at least an optical member, the first member, and the second member are disposed; a gas supply port that supplies second gas having a higher viscosity than viscosity of the first gas; and a suction port which is disposed between the first surface and the second surface, and suctions the second gas through at least a portion of the second gap.

An exposure apparatus according to an aspect of the present invention that exposes a substrate to exposure light through first liquid of a first liquid immersion space, includes: an optical member having an emission surface from which the exposure light is emitted; a first liquid immersion member which is disposed in at least a portion of the periphery of a light path of the exposure light, and forms the first liquid immersion space of the first liquid; a second liquid immersion member which is disposed at the outside of the first liquid immersion member with respect to the light path, and is capable of forming a second liquid immersion space of second liquid, separated from the first liquid immersion space; and a chamber device having an environmental control unit that supplies first gas to an internal space in which at least the optical member, the first liquid immersion member, and the second liquid immersion member are disposed, wherein the second liquid immersion member includes a first member having a first surface that faces an upper surface of an object via a first gap interposed therebetween and holds the liquid between the upper surface of the object and the first surface, a second member which is disposed at the outside of the first surface with respect to the center of the first surface, and has a second surface that faces the upper surface of the object via a second gap interposed therebetween, a gas supply port that supplies second gas having a higher viscosity than viscosity of the first gas, and a suction port which is disposed between the first surface and the second surface, and suctions the second gas through at least a portion of the second gap.

A device manufacturing method according to an aspect of the present invention includes: exposing a substrate using the exposure apparatus according to the above-mentioned aspects; and developing the exposed substrate.

A liquid holding method according to an aspect of the present invention used in an exposure apparatus that exposes a substrate to exposure light through liquid on the substrate, includes: holding the liquid between a first surface of a first member disposed in at least a portion of the periphery of a light path of the exposure light and an upper surface of an object, the first surface facing the upper surface of the object via a first gap interposed therebetween; and suctioning at least a portion of gas in a space located outside a second member with respect to the light path, through a second gap, from a suction port disposed between the first surface and a second surface of the second member disposed at the outside of the first surface with respect to the light path, the second surface facing the upper surface of the object via the second gap having a smaller size than the size of the first gap interposed therebetween.

A liquid holding method according to an aspect of the present invention used in an exposure apparatus that exposes a substrate to exposure light through liquid on the substrate, includes: holding the liquid between a first surface of a first member disposed in at least a portion of the periphery of a light path of the exposure light and an upper surface of an object, the first surface facing the upper surface of the object via a first gap interposed therebetween; suctioning at least a portion of gas in a space located outside a second member with respect to the light path, through a second gap, from a suction port disposed between the first surface and a second surface of the second member disposed at the outside of the first surface with respect to the light path, the second surface facing the upper surface of the object via the second gap interposed therebetween; supplying first gas from an environmental control unit to an internal space in which at least an optical member, the first member, and the second member are disposed; supplying second gas having a higher viscosity than viscosity of the first gas from a gas supply port; and suctioning the second gas from the suction port disposed between the first surface and the second surface through at least a portion of the second gap.

A liquid holding method according to an aspect of the present invention used in an exposure apparatus that exposes a substrate to exposure light through first liquid on the substrate, includes: holding second liquid between a first surface of as first member facing an upper surface of an object via a first gap interposed therebetween, and the upper surface of the object; suctioning at least a portion of gas in a space located outside a second surface with respect to the center of the first surface, through a second gap, from a suction port disposed between the first surface and the second surface of a second member disposed at the outside of the first surface with respect to the center of the first surface, the second surface facing the upper surface of the object via the second gap interposed therebetween; supplying first as from an environmental control unit to an internal space in which at least an optical member, the first member, and the second member are disposed; supplying second gas having a higher viscosity than viscosity of the first gas from a gas supply port; and suctioning the second gas from the suction port disposed between the first surface and the second surface through at least a portion of the second gap.

A device manufacturing method according to an aspect of the present invention includes: exposing a substrate through at least a portion of the liquid held by the liquid holding method according to the above-mentioned aspects; and developing the exposed substrate.

According to the aspects of the present invention, it is possible to suppress the generation of a defective exposure. In addition, according to aspects of the present invention, it is possible to suppress the generation of a defective device.

### BRIEF DESCRIPTION OF THE DRAWINGS

FIG. 1 is a schematic configuration diagram illustrating an example of an exposure apparatus according to a first embodiment.

FIG. 2 is a diagram illustrating a portion of the exposure apparatus according to the first embodiment.

FIG. 3 is a diagram illustrating a portion of an exposure apparatus according to a second embodiment.

FIG. 4 is a diagram illustrating a portion of an exposure apparatus according to a third embodiment.

FIG. 5 is a diagram illustrating a portion of the exposure apparatus according to the third embodiment.

FIG. 6 is a diagram illustrating a portion of the exposure apparatus according to the third embodiment.

FIG. 7 is a diagram illustrating, a portion of an exposure apparatus according, to a fourth embodiment.

FIG. 8 is a diagram illustrating a portion of the exposure apparatus according to the fourth embodiment.

FIG. 9 is a diagram illustrating a portion of the exposure apparatus according to the fourth embodiment.

FIG. 10 is a diagram illustrating a portion of the exposure apparatus according to the fourth embodiment.

FIG. 11 is a diagram illustrating a portion of the exposure apparatus according to the fourth embodiment.

FIG. 12 is a diagram illustrating an example of a substrate stage.

FIG. 13 is a flow diagram illustrating an example of a device manufacturing process.

### DESCRIPTION OF THE EMBODIMENTS

Hereinafter, embodiments according to the present invention will be described with reference to the drawings, but the present invention is not limited thereto. In the following description, an XYZ orthogonal coordinate system is set, and a positional relationship of each part will be described with reference to the XYZ orthogonal coordinate system. A predetermined direction within the horizontal plane is set to an X-axis direction, a direction orthogonal to the X-axis direction within the horizontal plane is set to a Y-axis direction, and a direction (that is, vertical direction) orthogonal to the X-axis direction and the Y-axis direction, respectively, is set to a Z-axis direction. In addition, rotational (tilting) directions around the X-axis, the Y-axis, and the Z-axis are set to a θX direction, a θY direction, and a θZ direction, respectively.

### First Embodiment

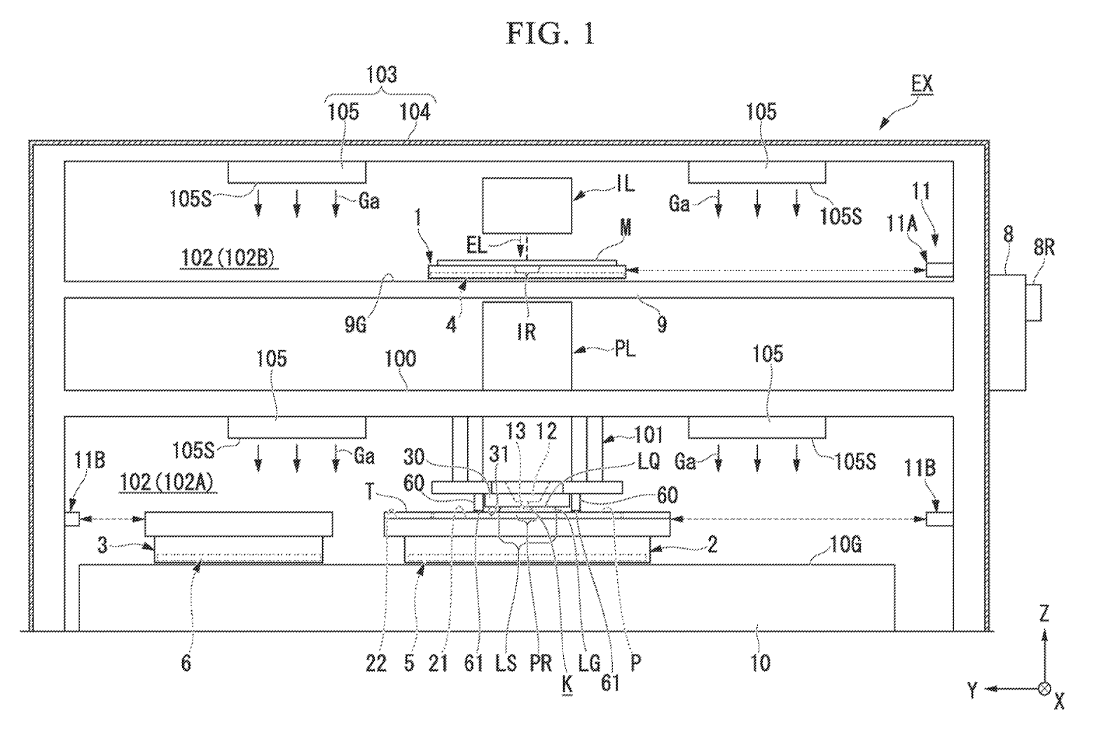

A first embodiment will be described below FIG. 1 is a schematic configuration diagram illustrating an example of an exposure apparatus EX according to the first embodiment. The exposure apparatus EX of the present embodiment is a liquid immersion exposure apparatus that exposes the substrate P with the exposure light EL through exposure liquid LQ. In the present embodiment, in at least a portion of the light path of the exposure light EL, a liquid immersion space LS is formed so as to be filled with the exposure liquid LQ. The liquid immersion space is a portion (a space or a region) which is filled with liquid. The substrate P is exposed with the exposure light EL through the exposure liquid LQ of the liquid immersion space LS. In the present embodiment, water (pure water) is used as the exposure liquid LQ.

In addition, the exposure apparatus EX of the present embodiment is, for example, an exposure apparatus including a substrate stage and a measurement stage as disclosed in Specification of U.S. Pat. No. 6,897,963, Specification of EP Patent Application Publication No. 1,713,113 and the like.

In FIG. 1, the exposure apparatus EX includes a movable mask stage 1 that holds a mask M, a movable substrate stage 2 that holds the substrate P, a movable measurement stage 3 on which a measurement member is mounted and a measurement instrument for measuring the exposure light EL without holding the substrate P, a drive system 4 that moves the mask stage 1, a drive system 5 that moves the substrate stage 2, a drive system 6 that moves the measurement stage 3, an illumination system IL that illuminates the mask M with the exposure light EL, a projection optical system PL that projects an image of a pattern of the mask M, illuminated with the exposure light EL, onto the substrate P, a first member 30 which is disposed in at least a portion of the periphery of a light path of the exposure light EL and has a first surface 31 facing the upper surface of an object via a first gap interposed therebetween and holding the liquid LQ between the upper surface of the object and the first surface, a second member 60 which is disposed at the outside of the first surface 31 with respect to the light path of the exposure light EL and has a second surface 61 facing the upper surface of the object via a second gap interposed therebetween, a measurement system 11 that measures positions of the mask stage 1, the substrate stage 2, and the measurement stage 3, a control device 8 that controls an operation of the entire exposure apparatus EX, and a storage device 8R, connected to the control device 8, which stores various types of information about an exposure. The storage device 8R includes, for example, a memory such as a RAM, a hard disk, and a recording medium such as CD-ROM. An operating system (OS) that controls a computer system is installed on the storage device SR, and a program for controlling the exposure apparatus EX is stored therein.

The mask M includes a reticle on which a device pattern projected onto the substrate P is formed. The mask M includes a transmissive mask having, for example, a transparent plate such as a glass plate, and a pattern formed on the transparent plate using a light-shielding material such as chrome. Meanwhile, a reflective mask can be used as the mask M.

The substrate P is a substrate for manufacturing a device. The substrate P includes, for example, a base material such as a semiconductor wafer, and a photosensitive film formed on the base material. The photosensitive film is a film of a photosensitive material (photoresist). In addition, the substrate P may include another film in addition to the photosensitive film. For example, the substrate P may include an antireflection film, and may include a protective film (top-coat film) that protects the photosensitive film.

In addition, the exposure apparatus EX includes a body 100 that supports at least the projection optical system PL. In addition, the exposure apparatus EX includes a chamber device 103 that adjusts the environment (at least one of temperature, humidity, pressure, and cleanliness level) of a space 102 to which the exposure light EL travels. The chamber device 103 includes a chamber member 104 in which the space 102 is formed, and an environmental control unit 105 that adjusts the environment of the space 102. The space 102 is an internal space formed by the chamber member 104. The body 100 is disposed in the space 102.

The space 102 includes a space 102A and a space 102B. The space 102A is a space in which the substrate P is processed. The substrate stage 2 and the measurement stage 3 moves in the space 102A.

The environmental control unit 105 includes an air supply portion 105S that supplies as Ga to the spaces 102A and 102B, and supplies the gas Ga from the air supply portion 105S to the spaces 102A and 102B and adjusts the environment of the spaces 102A and 102B. In the present embodiment, at least the substrate stage 2, the measurement stage 3, and a terminal optical element 12 of the projection optical system PL are disposed in the space 102A. In the present embodiment, the gas Ga supplied from the environmental control unit 105 to the space 102 is air.

The illumination system IL irradiates a predetermined illumination region IR with the exposure light EL. The illumination region IR includes a position which can be irradiated with the exposure light EL emitted from the illumination system IL. The illumination system IL illuminates at least a portion of the mask M disposed in the illumination region IR with the exposure light EL having a uniform illuminance distribution. As the exposure light EL emitted from the illumination system IL, for example, far-ultraviolet light (DUV light) such as emission lines (g line, h line, and i line) emitted from a mercury lamp and KrF excimer laser light (wavelength 248 nm), ArF excimer laser light (wavelength 193 nm), vacuum-ultraviolet light (VUV light) such as F₂ laser light (wavelength 157 nm), and the like are used. In the present embodiment, as the exposure light EL, ArF excimer laser light which is ultraviolet light (vacuum-ultraviolet light) is used.

The mask stage 1 can move on a guide surface 9G of a base member 9 including the illumination region IR in a state where the mask M is held. The drive system 4 includes a planar motor for moving the mask stage 1 on the guide surface 9G. The planar motor includes a slider disposed in the mask stage 1 and a stator disposed in the base member 9, for example, as disclosed in Specification of U.S. Pat. No. 6,452,292. In the present embodiment, the mask stage 1 can move on the guide surface 9G in the six directions of the X-axis, Y-axis, Z-axis, θX, θY, and θZ by operation of the drive system 4.

The projection optical system PL irradiates a predetermined projection region PR with the exposure light EL. The projection region PR includes a position which can be irradiated with the exposure light EL emitted from the projection optical system PL. The projection optical system PL projects an image of a pattern of the mask M, at a predetermined projection magnification, onto at least a portion of the substrate P disposed in the projection region PR. The projection optical system PL of the present embodiment is a reduction system of which the projection magnification is, for example, ¼, ⅕, ⅛ or the like. Meanwhile, the projection optical system PL may be any of an equalization system and a magnification system. In the present embodiment, the optical axis of the projection optical system PL is parallel to the Z-axis. In addition, the projection optical system PL may be any of a refraction system which does not include a reflective optical element, a reflection system which does not include a refractive optical element, and a reflection and refraction system which includes a reflective optical element and a refractive optical element. In addition, the projection optical system PL may form any of an inverted image and an erected image.

The substrate stage 2 can move a position (projection region PR) which can be irradiated with the exposure light EL emitted from the projection optical system PL. The substrate stage 2 can move on a guide surface 100 of a base member 10 including the projection region PR in a state where the substrate P is held. The measurement stage 3 can move a position which can be irradiated with (projection region PR) the exposure light EL emitted from the projection optical system PL. The measurement stage 3 can move on the guide surface 100 of the base member 10 including the projection region PR in a state where the measurement member is held. The substrate stage 2 and the measurement stage 3 can move on the guide surface 100 independently of each other.

The drive system 5 for moving the substrate stage 2 includes a planar motor for moving the substrate stage 2 on the guide surface 10G. The planar motor includes a slider disposed in the substrate stage 2 and a stator disposed in the base member 10, for example, as disclosed in Specification of U.S. Pat. No. 6,452,292. Similarly, the drive system 6 for moving the measurement stage 3 includes a planar motor, and includes a slider disposed in the measurement stage 3 and a stator disposed in the base member 10.

In the present embodiment, the substrate stage 2 includes a first holding portion 21 that releasably holds the lower surface of the substrate P and a second holding portion 22, disposed in the periphery of the first holding portion 21, which releasably holds the lower surface of a cover member T, for example, as disclosed in Specification of U.S. Patent Application Publication No. 2007/0,177,125, Specification of U.S. Patent Application Publication No. 2008/0,049,209 and the like. The cover member T is disposed in the periphery of the substrate P held by the first holding portion 21.

In the present embodiment, the first holding portion 21 holds the substrate P. The second holding portion 22 holds the cover member T. In the present embodiment, the upper surface of the substrate P held by the first holding portion 21 and the upper surface of the cover member T held by the second holding portion 22 are disposed in substantially the same plane (coplanar).

Meanwhile, the cover member T may be integrally formed on the substrate stage 2. In this case, the second holding portion 22 is omitted.

The measurement system 11 includes a unit 11A that measures the position of the mask stage 1 and a unit 11B that measures the positions of the substrate stage 2 and the measurement stage 3. The unit 11A can measure the position of the mask stage 1 using at least one of an interferometer system and an encoder system. The unit 11B can measure each of the positions of the substrate stage 2 and the measurement stage 3 using at least one of the interferometer system and the encoder system.

When an exposure process of the substrate P is performed, or when a predetermined measurement process is performed, the control device 8 brings the drive systems 4, 5, and 6 into operation on the basis of the measurement result of the measurement system 11, and controls the positions of the mask stage 1 (mask M), the substrate stage 2 (substrate P), and the measurement stage 3 (measurement member C).

The first member 30 can form the liquid immersion space LS so that at least a portion of the light path of the exposure light EL is filled with the liquid LQ. The first member 30 is disposed in the vicinity of the terminal optical element 12 which is closest to the image plane of the projection optical system PL among a plurality of optical elements of the projection optical system PL. In the present embodiment, the first member 30 is an annular member, and is disposed in the periphery of the light path of the exposure light EL. In the present embodiment, at least a portion of the first member 30 is disposed in the periphery of the terminal optical element 12

The terminal optical element 12 includes an emission surface 13 that emits the exposure light EL toward the image plane of the projection optical system PL. In the present embodiment, the liquid immersion space LS is formed at the emission surface 13 side. The liquid immersion space LS is formed so that a light path K of the exposure light EL emitted from the emission surface 13 is filled with the liquid LQ. The exposure light EL emitted from the emission surface 13 travels in the −Z direction. The emission surface 13 is directed to the travelling direction (−Z direction) of the exposure light EL. In the present embodiment, the emission surface 13 is a plane which is substantially parallel to the XY plane. Meanwhile, the emission surface 13 may be inclined toward the XY plane, and may include a curved surface.

The first member 30 includes the first surface 31 of which at least a portion is directed to the −Z direction. In the present embodiment, the emission surface 13 and the first surface 31 can hold the liquid LQ between the surfaces and the object which is disposed at a position which can be irradiated with (projection region PR) the exposure light EL emitted from the emission surface 13. The liquid immersion space LS is formed by the liquid LQ held between at least a portion of the emission surface 13 and the first surface 31 and the object disposed in the projection region PR. The liquid immersion space LS is formed so that the light path K of the exposure light EL between the emission surface 13 and the object which is disposed in the projection region PR is filled with the liquid LQ. The first member 30 can hold the liquid LQ between the object and the member so that the light path K of the exposure light EL between the terminal optical element 12 and the object is filled with the liquid LQ.

In the present embodiment, the object capable of being disposed in the projection region PR includes an object movable with respect to the projection region PR at the image plane side (emission surface 13 side of the terminal optical element 12) of the projection optical system PL. The object is movable with respect to the terminal optical element 12 and the first member 30. The object includes an upper surface (surface) capable of facing at least one of the emission surface 13 and the first surface 31. The upper surface of the object can form the liquid immersion space LS between the emission surface 13 and the upper surface. In the present embodiment, the upper surface of the object can form the liquid immersion space LS between the upper surface and at least a portion of the emission surface 13 and the first surface 31. The liquid LQ is held between the emission surface 13 and the first surface 31 on one side and the upper surface (surface) of the object on the other side, and thus the liquid immersion space LS is formed so that the light path K of the exposure light EL between the terminal optical demerit 12 and the object is tilled with the liquid LQ.

In the present embodiment, the object includes at least one of the substrate stage 2, the substrate P held by the substrate stage 2, the measurement stage 3, and the measurement member held by the measurement stage 3. For example, the upper surface of the substrate stage 2 (cover member T) and the surface (upper surface) of the substrate P held by the substrate stage 2 can face the emission surface 13 of the terminal optical element 12 directed to the −Z direction and the first surface 31 of the first member 30 directed to the −Z direction. Of course, the object capable of being disposed in the projection region PR is not limited to at least one of the substrate stage 2, the substrate P held by the substrate stage 2, the measurement stage 3, and the measurement member held by the measurement stage 3. That is, the liquid immersion space LS may be formed extending over two or more objects.

In addition, in the present embodiment, the object capable of being disposed in the projection region PR can face at least a portion of the second member 60. The object can face the second surface 61 of the second member 60.

In the present embodiment, when the substrate P is irradiated with the exposure light EL, the liquid immersion space LS is formed so that a region of a portion of the surface of the substrate P including, the projection region PR is covered with the liquid LQ. At the time of the exposure of the substrate P, the first member 30 can hold the liquid LQ between the substrate P and the member so that the light path K of the exposure light EL between the terminal optical element 12 and the substrate P is filled with the liquid LQ. At least a portion of an interface (a meniscus or an edge) LG of the liquid LQ is formed between the first surface 31 of the first member 30 and the surface of the substrate P. That is, in the exposure apparatus EX of the present embodiment, a local liquid immersion method is adopted.

In the present embodiment, the first member 30 and the second member 60 are supported by the body 100. In the present embodiment, the first member 30 and the second member 60 are supported by the body 100 through a support mechanism 101. In the present embodiment, the position of the support mechanism 101 (body 100) is substantially fixed. The upper surface of the object faces the first surface 31 of the first member 30 with the first gap interposed therebetween, and faces the second surface 61 of the second member 60 with the second gap interposed therebetween. Meanwhile, the first member 30 may be supported by a member different from the support mechanism 101. For example, the first member 30 may be supported by the body 100 through a support member different from the support mechanism 101, and may be supported by a support member that supports at least one optical element of the projection optical system PL.

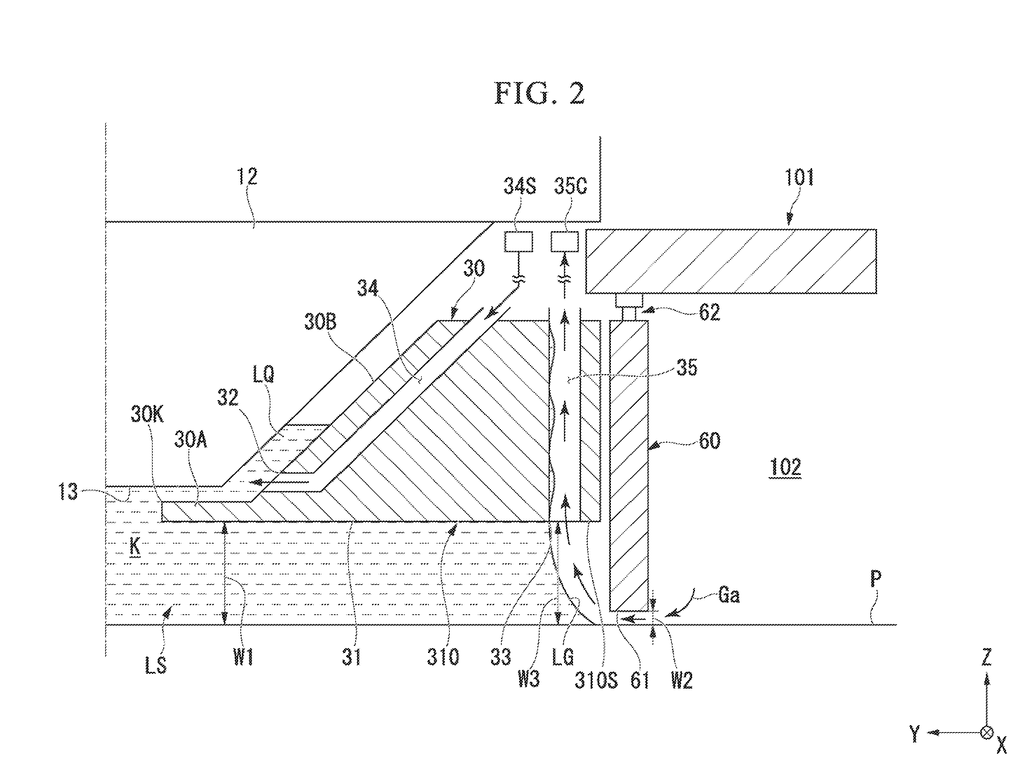

FIG. 2 is a diagram illustrating the vicinities of the first member 30 and the second member 60 according to the present embodiment. Meanwhile, in FIG. 2, the substrate P is disposed in the projection region PR (positions facing the terminal optical element 12, the first member 30, and the second member 60). However, as mentioned above, the substrate stage 2 (cover member T), the measurement stage 3 (measurement member) and the like can also be disposed therein.

As shown in FIG. 2, the first member 30 includes a facing portion 30A of which at least a portion faces the emission surface 13 of the terminal optical element 12, and a main body portion 30B of which at least a portion is disposed in the periphery of the terminal optical element 12. The facing portion 30A includes a hole (opening) 30K at a position facing the emission surface 13. The facing portion 30A includes an upper surface of which at least a portion faces the emission surface 13 with a gap interposed therebetween.

The first member 30 includes a lower surface 310 capable of facing the substrate P (object). The opening 30K is formed so as to link the upper surface of the facing portion 30A and the lower surface 310 to each other. The upper surface of the facing portion 30A is disposed in the periphery of the upper end of the opening 30K, and the lower surface 310 is disposed in the periphery of the lower end of the opening 30K. The exposure light EL emitted from the emission surface 13 passes through the opening 30K and the substrate P is irradiated with the exposure light.

In the present embodiment, each of the upper surface and the lower surface 310 of the facing portion 30A is disposed in the periphery of the light path K. In the present embodiment, the upper surface of the facing portion 30A is planar. In the present embodiment, the lower surface 310 is planar. The lower surface 310 includes the first surface 31 capable of holding the liquid LQ between the substrate P (object) and the lower surface. In the present embodiment, the lower surface 310 (first surface 31) is a plane which is substantially parallel to the XY plane. Meanwhile, the lower surface 310 (first surface 31) may be inclined toward the XY plane, and may include a curved surface.

In addition, the first member 30 includes a supply port 32 capable of supplying the liquid LQ, and a recovery port 33 capable of recovering the liquid LQ. The supply port 32 supplies the liquid LQ, for example, at the time of the exposure of the substrate P. The recovery port 33 recovers the liquid LQ, for example, at the time of the exposure of the substrate P. Meanwhile, the supply port 32 can supply the liquid LQ while one or both of exposing and non-exposing the substrate P. Meanwhile, the recovery port 33 can recover the liquid LQ while one or both of exposing and non-exposing the substrate P.

The supply port 32 is disposed so as to face the light path K in the vicinity of the light path K of the exposure light EL emitted from the emission surface 13. Meanwhile, the supply port 32 preferably faces one or both of the space between the emission surface 13 and the opening 30K and the lateral side of the terminal optical element 12. In the present embodiment, the supply port 32 supplies the liquid LQ to the space between the upper surface of the facing portion 30A and the emission surface 13. The liquid LQ supplied from the supply port 32 flows in the space between the upper surface of the facing portion 30A and the emission surface 13, and then is supplied onto the substrate P (object) through the opening 30K.

Meanwhile, the supply port 32 may be disposed in the lower surface 310. In other words, the supply port 32 may be disposed so as to face the object. In addition, another liquid supply port may be disposed in the lower surface 310, in addition to the supply port 32.

The supply port 32 is connected to a liquid supply device 34S through a flow channel 34. The liquid supply device 34S can send out the liquid LQ of which the temperature is adjusted by cleaning. At least a portion of the flow channel 34 is formed inside the first member 30. The liquid LQ sent out from the liquid supply device 34S is supplied to the supply port 32 through the flow channel 34. In the exposure of at least the substrate P, the supply port 32 supplies the liquid LQ.

The recovery port 33 can recover at least a portion of the liquid LQ located on the object facing the lower surface 310 of the first member 30. The recovery port 33 is disposed in at least a portion of the periphery of the opening 30K through which the exposure light EL passes. In the present embodiment, the recovery port 33 is disposed in at least a portion of the periphery of the first surface 31 capable of holding the liquid LQ between the object and the surface in the lower surface 310. That is, in the present embodiment, the lower surface 310 includes the first surface 31 disposed at the inside of the recovery port 33, which is capable of holding the liquid LQ between the object and the surface and forming the liquid immersion space LS, and the surface 310S disposed at the outside of the recovery port 33. The recovery port 33 is disposed so as to face the object. The recovery port 33 is disposed in a predetermined position of the first member 30 facing the surface of the object. In the exposure of at least the substrate P, the substrate P faces the recovery port 33. In the exposure of the substrate P, the recovery port 33 recovers the liquid LQ located on the substrate P.

The recovery port 33 is connected to a fluid recovery device 35C through a flow channel 35. In the fluid recovery device 35C, the recovery port 33 can be connected to a vacuum system, and the liquid LQ can be suctioned through the recovery port 33 and the flow channel 35. In addition, the fluid recovery device 35C can suction gas through the recovery port 33 and the flow channel 35. At least a portion of the flow channel 35 is formed inside the first member 30. One or both of the liquid LQ and the gas recovered (suctioned) from the recovery port 33 are recovered (suctioned) in the fluid recovery device 35C through the flow channel 35.

In the present embodiment, the control device 8 performs the operation of recovering the liquid LQ from the recovery port 33 concurrently with the operation of supplying the liquid LQ from the supply port 32, and thus the liquid immersion space LS can be formed by the liquid LQ between the terminal optical element 12 and the first member 30 on one side and the object on the other side.

Meanwhile, a liquid immersion member (nozzle member) as disclosed in, for example. Specification of U.S. Patent Application Publication No. 2007/0,132,976 and Specification of EP Patent Application Publication No. 1,768,170 can be used as the first member 30.

The second member 60 includes the second surface 61 capable of facing the substrate P (object). In the present embodiment, the second surface 61 is disposed in the light path K and in the periphery of the first member 30. In the present embodiment, the second surface 61 is planar, and is parallel to the XY plane. Meanwhile, the second surface 51 may be inclined toward the XY plane, and may include a curved surface. In addition, in the present embodiment, the second surface 61 of the second member 60 is not provided with a suction port.

As shown in FIG. 2, in the present embodiment, a first gap W1 is formed between the first surface 31 and the upper surface (upper surface of the object) of the substrate P. A second gap W2 is formed between the second surface 61 and the upper surface (upper surface of the object) of the substrate P. In the present embodiment, the size of the second gap W2 is smaller than the size of the first gap W1. The first gap W1 is 0.5 mm to 1.0 mm. The second gap W2 is 0.1 mm to 0.2 mm. The first gap W1 is four or more times the second gap W2, or five or more times that. In the present embodiment, the first gap W1 is 1.0 mm, and the second gap W2 is 0.2 mm.

In the present embodiment, the recovery port 33 is disposed between the first surface 31 and the second surface 61. The recovery port 33 is disposed so as to face the substrate P (object). In the present embodiment, the size of a third gap W3 between the recovery port 33 and the upper surface (upper surface of the object) of the substrate P is larger than the size of the second gap W2.

In the present embodiment, the size of the first gap W1 and the size of the third gap W3 are nearly equal to each other. Meanwhile, the size of the first gap W1 may be larger than the size of the third gap W3, or may be smaller than that.

In the present embodiment, the recovery port 33 suctions (discharges) at least a portion of the gas in the space outside the second member 60 with respect to the light path K through the second gap W2. In the present embodiment, the space outside the second member 60 with respect to the light path K is the space 102 (102A) formed by the chamber member 104. The recovery port 33 suctions at least a portion of the gas Ga from the environmental control unit 105 through the second gap W2.

As mentioned above, in the present embodiment, the recovery port 33 can also suction at least a portion of the liquid LQ supplied between the first surface 31 and the upper surface of the object. For example, in the exposure of the substrate P, the recovery port 33 can suction the liquid LQ and the gas Ga at the same time. As shown in FIG. 2, the fluid recovery device 35C suctions the liquid LQ through the recovery port 33 so that the pathway of the gas Ga is maintained in the flow channel 35.

In addition, in the present embodiment, the exposure apparatus EX includes a driving device 62 having an actuator capable of moving the second member 60. In the present embodiment, the driving device 62 is disposed between the support mechanism 101 and the second member 60. The driving device 62 can move the second member 60 with respect to the support mechanism 101. The driving device 62 can move the second member 60 in at least the Z-axis direction. The driving device 62 can adjust the size of the second gap W2 by moving the second member 60. En the present embodiment, the driving device 62 can move the second member 60 in the six directions of X-axis, Y-axis, Z-axis, θX, θY, and θZ. Meanwhile, the second member 60 may be capable of being moved in at least one direction of the six directions of X-axis, Y-axis, Z-axis, θX, θY, and θZ. For example, the member may be just moved in the Z-axis direction, and may be just moved in three directions of Z-axis, θX, and θY.

In the present embodiment, the driving device 62 moves the second member 60 so that the second member 60 does not come into contact with the substrate P (object) and the size of the second gap W2 becomes a target value.

Meanwhile, in the present embodiment, although the position of the first member 30 is substantially fixed, for example, a driving device capable of moving the first member 30 may be provided, and the first member 30 may be moved using the driving device. For example, the driving device may be controlled so that the first member 30 and the second member 60 are moved at the same time.

Next, an example of a method of exposing the substrate P using the exposure apparatus EX will be described. In order to expose the substrate P, the liquid immersion space LS is formed by the liquid LQ on the substrate P held by the first holding portion 31. In order to form the liquid immersion space LS, the control device 8 supplies the liquid LQ from the supply port 32 in a state where the terminal optical element 12 and the first member 30 are caused to face the substrate P (substrate stage 2), and recovers the liquid LQ from the recovery port 33. In the present embodiment, the interface LG of the liquid LQ of the liquid immersion space LS is, for example, formed further inside than the recovery port 33. In the example shown in FIG. 2, the interface LG of the liquid LQ of the liquid immersion space LS is, for example, formed so as to link the outer edge of the first surface 31 to the upper surface of the substrate P.

The control device 8 suctions the liquid LQ from the recovery port 33 so that the pathway of the gas Ga is maintained in the flow channel 35 by controlling the liquid recovery device 35C. In other words, the liquid recovery device 35C is controlled so that the liquid LQ and the gas Ga are constantly recovered (suctioned) from the recovery port 33 at the same time. Meanwhile, when the pathway of the gas Ga is maintained in the flow channel 35, the liquid LQ may not be recovered at all times, and may, for example, be intermittently recovered.

After the liquid immersion space LS is formed by the liquid LQ between the terminal optical element 12 and the first member 30, and the substrate P (substrate stage 2), the control device 8 starts a process of exposing the substrate P.

The exposure apparatus EX of the present embodiment is a scanning-type exposure apparatus (so-called scanning stepper) that projects the image of the pattern of the mask M onto the substrate P while synchronously moving the mask M and the substrate P in a predetermined scanning direction. In the present embodiment, the scanning direction (synchronous movement direction) of the substrate P is set to the Y-axis direction, and the scanning direction (synchronous movement direction) of the mask M is also set to the Y-axis direction. The control device 8 irradiates the substrate P with the exposure light EL through the projection optical system PL and the liquid LQ of the liquid immersion space LS on the substrate P, while moving the substrate P at a predetermined scanning speed in the Y-axis direction with respect to the projection region PR of the projection optical system PL, and moving the mask M at a predetermined scanning speed in the Y-axis direction with respect to the illumination region IR of the illumination system IL in synchronization with the movement of the substrate P in the Y-axis direction. Thereby, the substrate P is exposed with the exposure light EL through the liquid LQ, and the image of the pattern of the mask M is projected onto the substrate P through the projection optical system PL and the liquid LQ.

In the present embodiment, in the exposure of at least the substrate P, the gas Ga of the space outside the second member 60 continues to be suctioned from the recovery port 33 through the second gap W2. Thereby, for example, even when the substrate P (object) moves in a state where the liquid immersion space LS is formed, the outflow of the liquid LQ of the liquid immersion space LS from the space between the first surface 31 and the upper surface of the substrate P (object) to the outside is suppressed.

In addition, the driving device 62 moves the second member 60 in accordance with a change in the position of the surface of the substrate P (object) so that the second member 60 does not come into contact with the substrate P (object) and the second gap W2 is substantially constantly maintained.

In the present embodiment, at least a portion of the gas in the space located outside of the second member 60 with respect to the light path K is suctioned from the recovery port 33 formed at the inside of the second member 60 through the second gap W2 having a size sufficiently smaller than that of the first gap W1, so that a difference occurs between the pressure of the space located outside of the second member 60 and the pressure of the space located inside the second member 60. For example, the pressure of the space (the space near the recovery port 33, or the space around the interface LG) located inside of the second member 60 becomes lower than the pressure of the space located outside of the second member 60. In addition, the recovery port 33 suctions the gas in the space located outside of the second member 60 through the second gap W2, so that a flow of the gas from the outside of the interface LG toward the interface LG is generated.

In the present embodiment, the size of the second gap W2 is sufficiently smaller than the size of the first gap W1. For this reason, the gas Ga in the space located outside of the second member 60 with respect to the light path K is suctioned from the recovery port 33 through the second gap W2, so that the pressure difference between the space located outside of the second member 60 and the space located inside thereof increases.

Thereby, an outflow of the liquid LQ of the liquid immersion space LS is suppressed.

As described above, according to the present embodiment, since at least a portion of the gas Ga of the space located outside of the second member 60 with respect to the light path K is suctioned from the suction port 33 disposed in the space located inside of the second member 60 through the second gap W2, the pressure difference by which an outflow of the liquid LQ of the liquid immersion space LS is suppressed and a flow of gas are generated in the periphery of the interface LG of the liquid immersion space LS. Therefore, it is possible to suppress the generation of a defective exposure and the generation of a defective device.

### Second Embodiment

Next, a second embodiment will be described. In the following description, the same reference signs and numerals are given to the same components as those of the above-mentioned embodiment, and a description thereof will be simplified or omitted here.

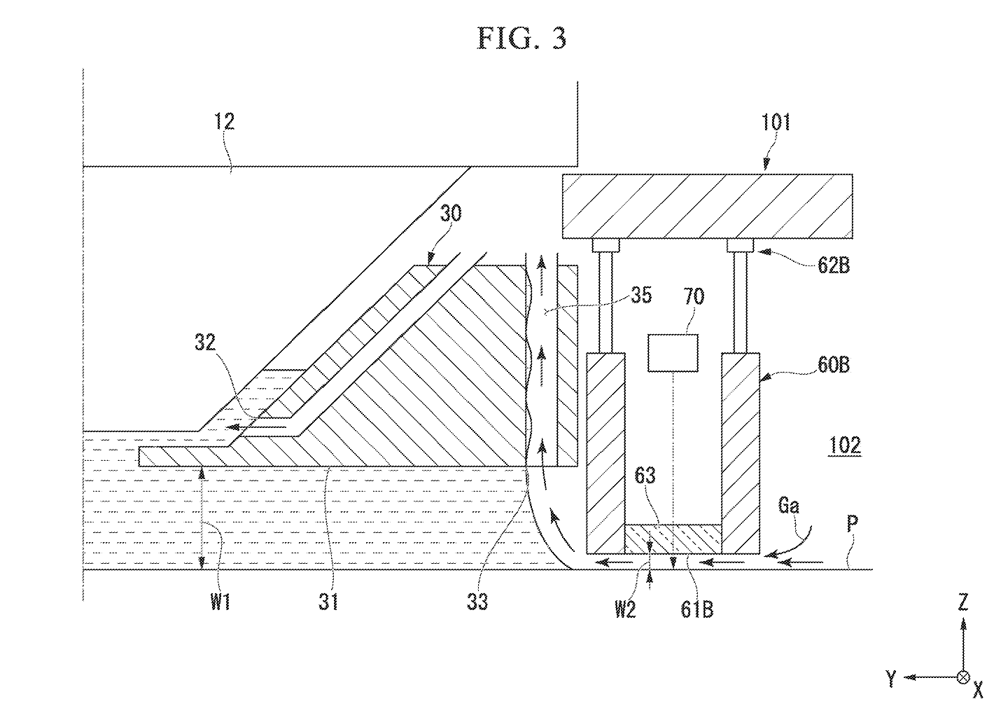

FIG. 3 is a diagram illustrating an example of an exposure apparatus EX according to the present embodiment. In FIG. 3, the exposure apparatus EX includes a detection device 70 that detects the size of the second gap W2 between a lower surface 61B of a second member 60B and the upper surface of the object. In addition, the exposure apparatus EX includes a driving device 628 capable of moving the second member 60B. In the present embodiment, the driving device 62B moves the second member 60B on the basis of the detection result of the detection device 70.

In the present embodiment, the second member 60B includes a transparent member 63 having the second surface 61B. In the present embodiment, the detection device 70 detects the size of the second gap W2 through the transparent member 63. In the present embodiment, the detection device 70 includes an irradiation portion that irradiates the upper surface of the transparent member 63 with detection light, and a receiving portion that receives the detection light. A portion of the detection light emitted from the irradiation portion is reflected from the upper surface of the transparent member 63. The detection light reflected from the upper surface of the transparent member 63 is received in the receiving portion. In addition, a portion of the detection light emitted from the irradiation portion passes through the transparent member 63, is applied to the upper surface of the object, and is reflected from the upper surface of the object. The detection light reflected from the upper surface of the object is received in the receiving portion through the transparent member 63. In the present embodiment, the detection device 70 detects the size of the second gap W2 between the second surface 61B and the upper surface of the object, on the basis of the detection light reflected from the upper surface of the transparent member 63 and the detection light reflected from the upper surface of the object. The driving device 62B moves the second member 60B in the Z direction so that the second gap W2 is substantially constantly maintained, on the basis of the detection result of the detection device 70.

Meanwhile, the detection device 70 may include, for example, an image capturing device capable of capturing an image of the second gap W2 (between the second member 60B and the object) from the lateral sides of the second member 60B and the object. The driving device 62B may move the second member 60B on the basis of the image capturing result of the image capturing device, to adjust the size of the second gap W2.

In addition, in the present embodiment, the optical detection device 70 is used, but other types of detection devices such as a capacitance-type measurement instrument and an air micrometer may be used.

### Third Embodiment

Next, a third embodiment will be described. In the following description, the same reference signs and numerals are given to the same components as those of the above-mentioned embodiment, and a description thereof will be simplified or omitted here.

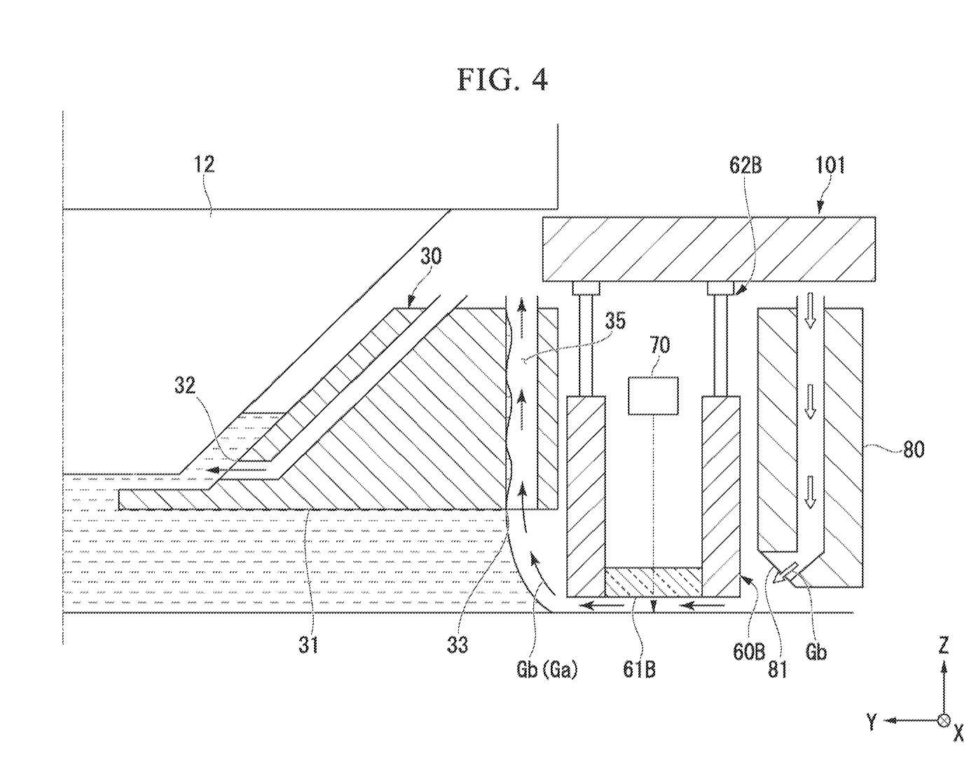

FIG. 4 is a diagram illustrating an example of an exposure apparatus EX according to a third embodiment. In FIG. 4, the exposure apparatus EX is disposed at the outside of the second member 60B with respect to the light path K, and includes a supply member 80 having a supply port 81 that supplies gas Gb to the second gap W2. In the present embodiment, the recovery port 33 suctions the gas Gb from the supply port 81. Meanwhile, the recovery port 33 may suction the gas Ga together with the gas Gb.

In the present embodiment, the viscosity of the gas Gb supplied from the supply port 81 is higher than the viscosity of the gas Ga supplied from the environmental control unit 105. In the present embodiment, the gas Ga is air, and the gas Gb is argon gas. Meanwhile, the gas Ga may not be air, and gas different from argon gas may be used as the gas Gb. In the present embodiment, since the gas Ga is air, as the gas Gb having a higher viscosity than that of the gas Ga, for example, at least one gas of neon, krypton, xenon, dimethyl ether, and fluorine may be used.

Meanwhile, the viscosity coefficients of air and gas mentioned above as disclosed in “Heat Transfer Optics Materials, Fourth Revised Edition (Japan Society of Mechanical Engineers)” are as follows.

Air: 18.4 (μPa·s)

Argon: 22.61 (μPa·s)

Neon: 31.58 (μPa·s)

Krypton: 25.39 (μPa·s)

Xenon: 23.18 (μPa·s)

Dimethyl ether: 25.0 (μPa·s)

Fluorine: 23.5 (μPa·s)

The gas Gb having a high viscosity is supplied from the supply port 81, and at least a portion of the gas Gb is suctioned from the recovery port 33 through the second gap W2, so that the pressure difference between the space located outside of the second member 60B and the space located inside thereof further increases. Thereby, an outflow of the liquid LQ is suppressed.

Meanwhile, even when the gas Gb different from the gas Ga supplied from the environmental control unit 105 is supplied to the space 102A, the gas Gb is recovered from the recovery port 33. Therefore, the influence on the measurement of a measurement device disposed in the space 102A, for example, the unit 11B of the measurement system 11 is small due to the supply of the gas Gb. Meanwhile, a suction port capable of removing the gas Gb may be separately provided, at the outside of the supply port 81 with respect to the light path of the exposure light in order to prevent the gas Gb from being diffused.

Meanwhile, in the present embodiment, the supply port 81 is disposed in the supply member 80 separate from the second member 60B, but may be disposed in the second member 60B. For example, the supply port 81 may be provided in the lower surface 61B of the second member 60B.

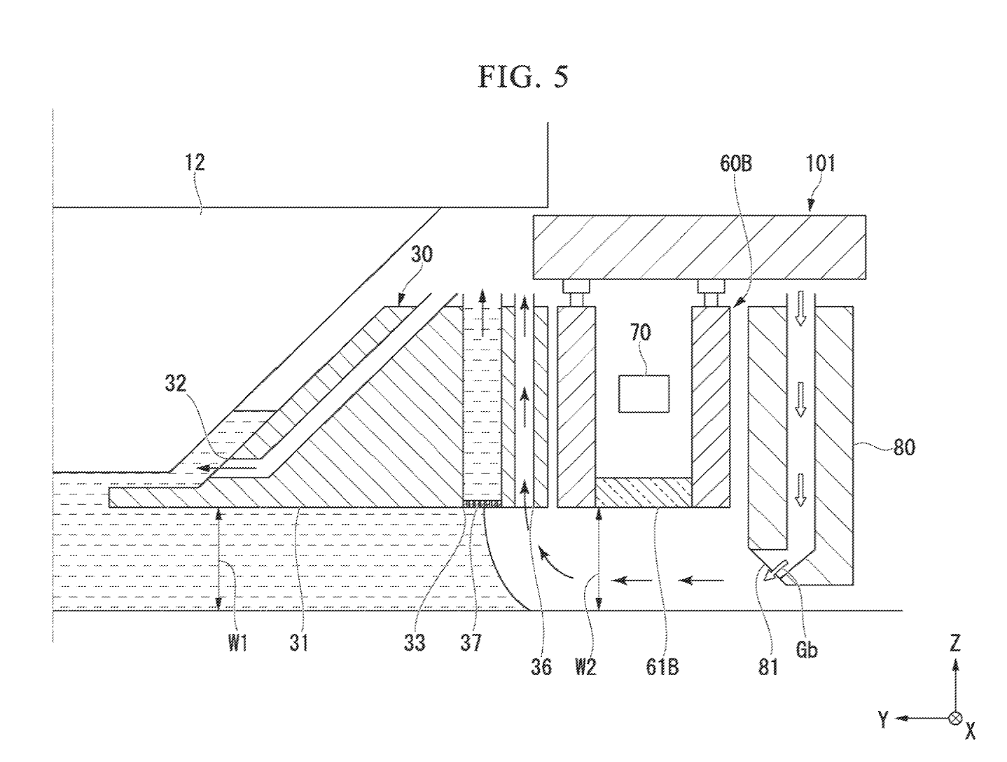

Meanwhile, in the present embodiment, when the gas Gb having a higher viscosity than that of the gas Ga is supplied from the supply port 81, the second gap W2 may not be smaller than the first gap W1. For example, as shown in FIG. 5, even when the size of the first gap W1 and the size of the second gap W2 are nearly equal to each other, the gas Gb supplied from the supply port 81 is suctioned from the recovery port 33, so that it is possible to increase the pressure difference between the space located outside of the second member 60B and the space located inside of the second member 60B, and to suppress an outflow of the liquid LQ.

Meanwhile, in the third embodiment, as shown in FIG. 5, the recovery port 33 for recovering the liquid LQ and a suction port 36 for suctioning gas in the space located outside of the second member 60B through the second gap W2 may be separate openings. That is, the suction port 36 may be provided at the outside of the recovery port 33 with respect to the light path of the exposure light. In addition, the suction port 36 may be provided in the first member 30.

Meanwhile, as shown in FIG. 5, when the suction port 36 is provided, a porous member 37 may be disposed in the recovery port 33. That is, the liquid LQ on the substrate P may be recovered through holes of the porous member 37. Meanwhile, the porous member 37 may be a plate-shaped member including a plurality of holes (openings or pores). Meanwhile, the porous member 37 may be a mesh filter in which numerous small holes are formed in a mesh shape. Of course, even when the suction port 36 is provided, the porous member 37 may not be disposed in the recovery port 33.

In addition, the gas Gb recovered from the recovery port 33 or the suction port 36 may be reused.

Meanwhile, in the third embodiment, the suction port 36 may be provided in the first member 30 of FIG. 4, and the suction port 36 may be provided in the first member 30 in at least one of the first embodiment and the second embodiment.

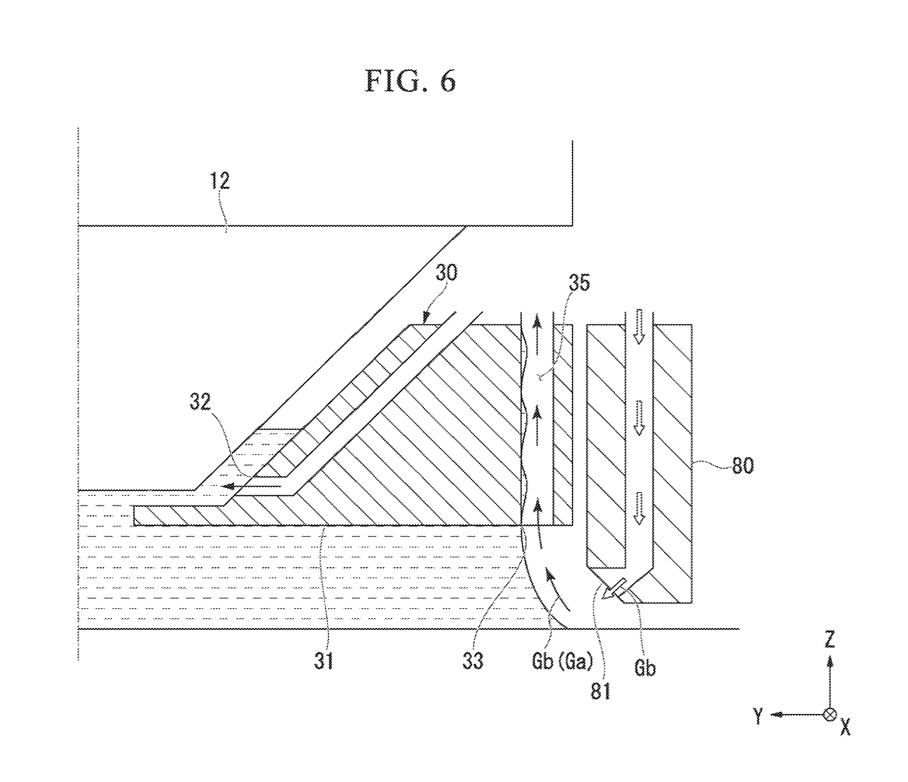

Meanwhile, in the third embodiment, as shown in FIG. 6, the second member 60B may not be included. The gas Gb having a higher viscosity than the gas Ga may be supplied from the supply port 81 of the supply member 80 to the periphery of the liquid immersion space LS. At least a portion of the gas Gb from the supply port 81 is recovered from the recovery port 33 of the first member 30.

In addition, the suction port 36 may not be provided in the first member 30. For example, the suction port may be provided in the second member (60 or 60B), and may be provided in a member different from the first member 30 and the second member (60 or 60B).

Meanwhile, in the third embodiment, the gas Gb may not be supplied at all times in the period of time in which the liquid immersion space LS is formed. For example, when the object moves (for example, the object moves at a speed slower than the scanning speed of the substrate P) under the conditions in which the object (substrate P or the like) facing the first member 30 does not cause leakage of the liquid LQ from the liquid immersion space LS, the gas Gb may not be supplied.

In addition, the gas Gb may not be supplied from all the directions in the periphery (periphery of the liquid immersion space LS) of the light path of the exposure light. That is, the gas Gb may be caused to flow toward the light path of the exposure light only from the direction of a portion of the periphery (periphery of the liquid immersion space LS) of the light path of the exposure light. For example, the gas Gb may be caused to flow toward the light path of the exposure light only from the direction of a portion of the periphery (periphery of the liquid immersion space LS) of the light path of the exposure light in which leakage of the liquid LQ from the liquid immersion space LS easily occurs. For example, when a plurality of supply ports 81 are provided in the periphery (periphery of the liquid immersion space LS) of the light path at the exposure light, and the object (substrate P or the like) facing the first member 30 moves in a first direction, the gas Gb may be supplied only from some of the supply ports 81 located in the travelling direction thereof. When the object moves in a second direction, the gas Gb may be supplied only from some of the other supply ports 81 located in the travelling direction thereof.

Meanwhile, in the above-mentioned first to third embodiments, the first member 30 and the second member 60 (60B) are separated from each other, but at least a portion thereof may come into contact with each other, and may be coupled to each other by a coupling member. In addition, the first member 30 and the second member 60 (60B) may be integrally formed.

Meanwhile, in the above-mentioned first to third embodiments, the second member (60 or 60B) may be moved in accordance with a change in the position of the surface of the object facing the lower surface (61 or 61B) of the second member (60 or 60B), but the second member 60 may not be moved. For example, before the liquid immersion space LS is formed using the XY plane intersecting at the image surface position on the optical axis of the projection optical system PL as a reference plane, the second member (60 or 60B) may be moved in the Z direction so that the second gap W2 is formed between the lower surface (61 or 61B) of the second member (60 or 60B) and the reference plane, and the second member (60 or 60B) may be fixed while the liquid immersion space LS is formed. In this case, the second member (60 or 60B) may be moved in the +Z direction while the liquid immersion space LS is not formed.

In addition, in the above-mentioned first to third embodiments, the second member (60 or 60B) is moved using a driving device, but the driving device may be omitted and the second member (60 or 60B) may be fixed.

### Fourth Embodiment

Next, a fourth embodiment will be described. In the following description, the same reference signs and numerals are given to the same components as those of the above-mentioned embodiment, and a description thereof will be simplified or omitted here.

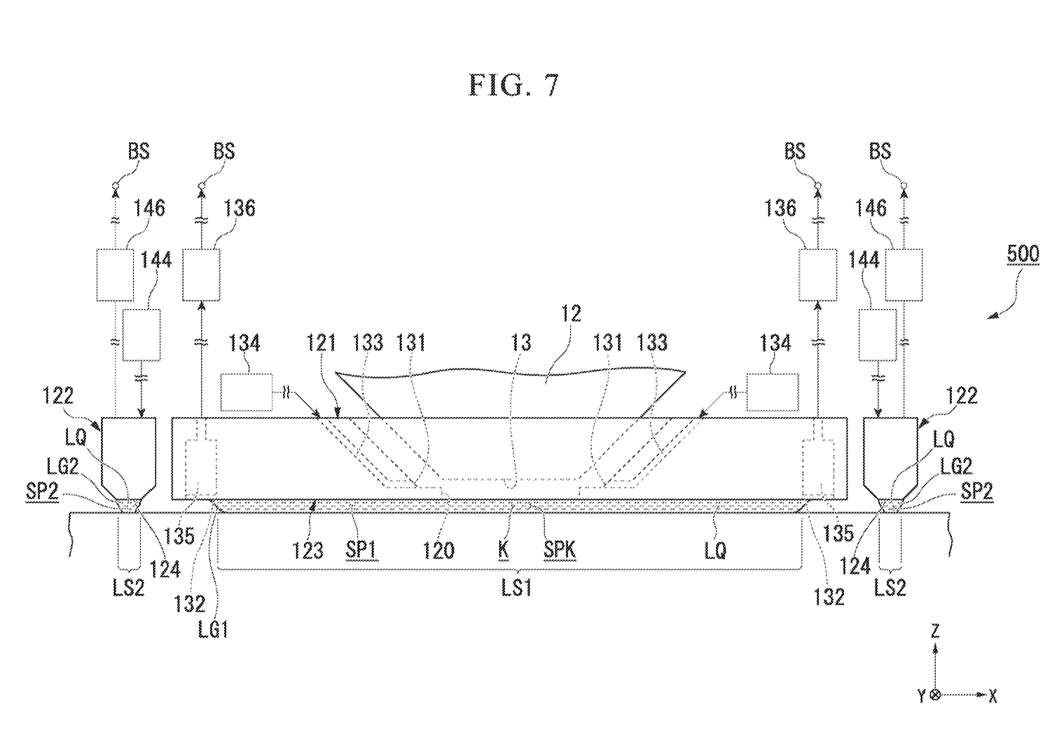

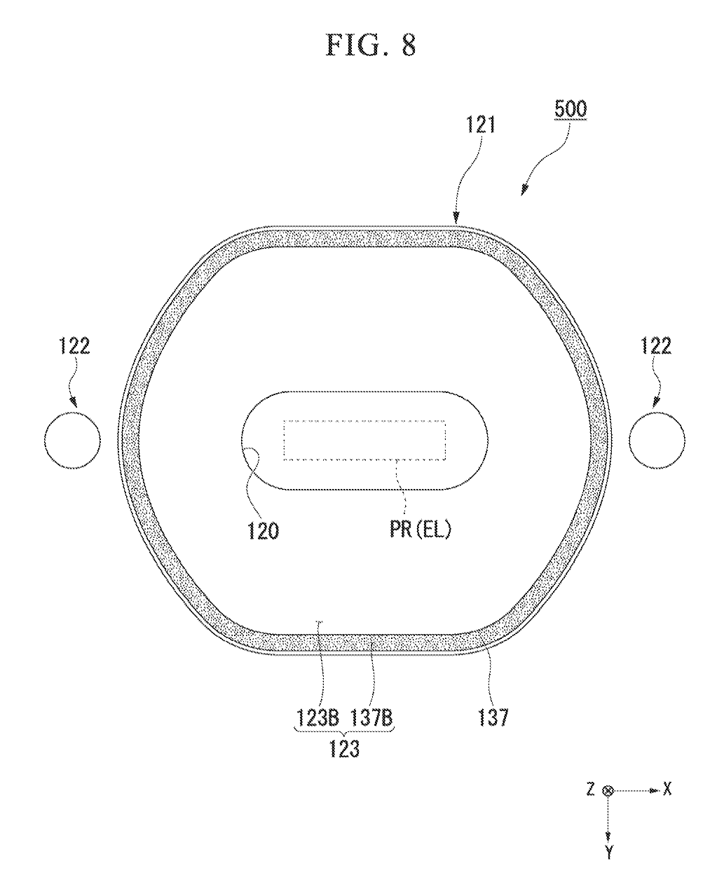

FIG. 7 is a side view illustrating an example of a liquid immersion member 500 according to the present embodiment, FIG. 8 is a diagram when the liquid immersion member 500 is viewed from the lower side (−Z side).

The liquid immersion member 500 includes a first liquid immersion member 121 disposed in at least a portion of the periphery of a terminal optical element 12, and a second liquid immersion member 122 disposed at the outside of the first liquid immersion member 121 with respect to the light path K (optical axis of the terminal optical element 12) of the exposure light EL emitted from an emission surface 13. The first liquid immersion member 121 forms a liquid immersion space LS1 of the liquid LQ. The second liquid immersion member 122 can form a liquid immersion space LS2 of the liquid LQ separated from the liquid immersion space LS1. The liquid immersion space LS1 is formed in at least a portion of the first space SP1 located below the first liquid immersion member 121. The liquid immersion space LS2 is formed in at least a portion of the second space SP2 located below the second liquid immersion member 122.

The terminal optical element 12, the first liquid immersion member 121, and the second liquid immersion member 122 are disposed in the space 102 (102A) of the chamber device 103. The space 102 is supplied with the gas Ga from the air supply portion 105S of the environmental control unit 105.

The first liquid immersion member 121 includes a lower surface 123. The second liquid immersion member 122 includes a lower surface 124. The lower surface 123 and the lower surface 124 can face an object movable below the terminal optical element 12. The object movable below the terminal optical element 12 can face the emission surface 13. The object can be disposed at the projection region PR. The object can move within the XY plane including the projection region PR. The object can move below the first liquid immersion member 121. The object can move below the second liquid immersion member 122.

In the present embodiment, the object includes at least one of the substrate stage 2, the substrate P held by the substrate stage 2, and the measurement stage 3.

In the following description, the object movable below the terminal optical element 12 is the substrate P. Meanwhile, as mentioned above, the object movable below the terminal optical element 12 may be at least one of the substrate stage 2 and the measurement stage 3, and may be a separate object from the substrate P, the substrate stage 2, and the measurement stage 3.

The first liquid immersion member 121 forms the liquid immersion space LS1 of the liquid LQ so that the light path K of the exposure light EL on the emission surface 13 side is filled with the liquid LQ. The liquid immersion space LS1 is formed so that the light path K between the emission surface 13 and the upper surface of the substrate P (object) is filled with the liquid LQ.

The first liquid immersion member 121 forms the liquid immersion space LS1 of the liquid LQ in at least a portion of a light path space SPK including the light path K on the emission surface 13 side and the first space SP1 on the lower surface 23 side. The liquid LQ can be held between the substrate P (object), and the terminal optical element 12 and the first liquid immersion member 121. The liquid immersion space LS1 is formed by the liquid LQ held between the terminal optical element 12 and the first liquid immersion member 121, and the substrate P. The liquid LQ is held between the emission surface 13 and the lower surface 23 on one side and the upper surface of the substrate P (object) on the other side, and thus the liquid immersion space LS1 is formed so that the light path K of the exposure light EL between the terminal optical element 12 and the substrate P is filled with the liquid LQ.

In the exposure of the substrate P, the liquid immersion space LS1 is formed so that the light path K of the exposure light EL with which the substrate P is irradiated is filled with the liquid LQ. When the substrate P is irradiated with the exposure light EL, the liquid immersion space LS1 is formed so that only a region of a portion of the surface of the substrate P including the projection region PR is covered with the liquid LQ.

In the present embodiment, at least a portion of an interface (a meniscus or an edge) LG1 of the liquid LQ of the liquid immersion space LS1 is formed between the lower surface 23 and the upper surface of the substrate P. That is, in the exposure apparatus EX of the present embodiment, a local liquid immersion method is adopted. The outer side (outer side of the interface LG1) of the liquid immersion space LS1 is a gas space.

In the present embodiment, the first liquid immersion member 121 is an annular member. In the present embodiment, a portion of the first liquid immersion member 121 is disposed in the periphery of the terminal optical element 12. In addition, a portion of the first liquid immersion member 121 is disposed in the periphery of the light path K of the exposure light EL between the terminal optical element 12 and the substrate P.

Meanwhile, the first liquid immersion member 121 may not be an annular member. For example, the first liquid immersion member 121 may be disposed in a portion of the periphery of the terminal optical element 12 and the light path K. Meanwhile, the first liquid immersion member 121 may not be disposed in at least a portion of the periphery of the terminal optical element 12. For example, the first liquid immersion member 121 may be disposed in at least a portion of the periphery of the light path K between the emission surface 13 and the substrate P, and may not be disposed in the periphery of the terminal optical element 12. Meanwhile, the first liquid immersion member 121 may not be disposed in at least a portion of the periphery of the light path K between the emission surface 13 and the substrate P. For example, the first liquid immersion member 121 may be disposed in at least a portion of the periphery of the terminal optical element 12, and may not be disposed in the periphery of the light path K between the emission surface 13 and the object.

The first liquid immersion member 121 includes a supply port 131 that supplies the liquid LQ for forming the liquid immersion space LS1, and a recovery port 132 that recovers at least a portion of the liquid LQ of the liquid immersion space LS1.

The supply port 131 is disposed so as to face the light path space SPK (light path K). The supply port 131 is connected to a liquid supply device 134 capable of supplying the liquid LQ through a supply flow channel 133 formed inside the first liquid immersion member 121. The supply port 131 supplies the liquid LQ from the liquid supply device 134 to the light path space SPK (light path K) on the emission surface 13 side.

The first liquid immersion member 121 includes a hole (opening) 120 facing the emission surface 13. The exposure light EL emitted from the emission surface 13 passes through the opening 120 and the substrate P can be irradiated with the exposure light. At least a portion of the liquid LQ supplied from the supply port 131 to the light path space SPK is supplied onto the substrate P (object) through the opening 120. In addition, at least a portion of the liquid LQ supplied from the supply port 131 to the light path space SPK is supplied to the first space SP1 through the opening 120. In the present embodiment, the liquid LQ is supplied from the opening 120 to the first space SP1 located below the first liquid immersion member 121.

The recovery port 132 is disposed so as to face the first space SP1. The substrate P (object) can face the recovery port 132. The recovery port 132 is connected to a liquid recovery device 136 capable of recovering (suctioning) the liquid LQ through a recovery flow channel 135 formed inside the first liquid immersion member 121. The recovery port 132 can recover (suction) at least a portion of the liquid LQ of the first space SP1 between the first liquid immersion member 121 and the substrate P. The liquid LQ flowing from the recovery port 132 to the recovery flow channel 135 is recovered in the liquid recovery device 136. The liquid recovery device 136 can connect the recovery port 132 to a vacuum system BS.

In the present embodiment, the first liquid immersion member 121 includes a porous member 137. The porous member 137 includes a plurality of holes (openings or pores) through which the liquid LQ can circulate. The porous member 137 includes, for example, a mesh filter. The mesh filter is a porous member in which numerous small holes are formed in a mesh shape.

In the present embodiment, the porous member 137 is a plate-shaped member. The porous member 137 includes a lower surface 137B capable of facing the substrate P, an upper surface facing the recovery flow channel 135 formed in the first liquid immersion member 121, and a plurality of holes formed so as to link the upper surface and the lower surface 137B. In the present embodiment, the recovery port 132 includes holes of the porous member 137. The liquid LQ recovered through the holes (recovery port 132) of the porous member 137 flows in the recovery flow channel 135.

In the present embodiment, both the liquid LQ and the gas of the first space SP1 are recovered (suctioned) from the porous member 137 (recovery port 132). Meanwhile, only the liquid LQ may be substantially recovered through the porous member 137, and the recovery of the gas may be restricted. Meanwhile, the porous member 37 may not be provided.

In the present embodiment, the recovery of the liquid LQ from the recovery port 132 is performed concurrently with the supply of the liquid LQ from the supply port 131, and thus the liquid immersion space LS1 of the liquid LQ is formed between the terminal optical element 12 and the first liquid immersion member 121 on one side and the substrate P on the other side. The liquid immersion space LS1 is formed by the liquid LQ supplied from the supply port 131.

The lower surface 123 is disposed in the periphery of the opening 120. In the present embodiment, at least a portion of the lower surface 123 is substantially parallel to the XY plane. Meanwhile, at least a portion of the lower surface 123 may be inclined toward the XY plane, and may include a curved surface.

The lower surface 123 includes a lower surface 123B, disposed in the periphery of the opening 120, which is not capable of recovering the liquid LQ, and a lower surface 137B of the porous member 137, disposed in the periphery of the lower surface 123B, which is capable of recovering the liquid LQ. The liquid LQ cannot pass through the lower surface 123B. The liquid LQ can be held between the lower surface 123B and the substrate P.

In the present embodiment, the lower surface 137B capable of recovering, the liquid LQ is disposed at the margin of the lower surface 123. The lower surface 137B is annular within the XY plane parallel to the lower surface 123 (upper surface of the substrate P). The lower surface 123B which is not, capable of recovering the liquid LQ is disposed at the inside of the lower surface 137B. In the present embodiment, the interface LG1 is disposed between the lower surface 137B and the upper surface of the substrate P.

Meanwhile, a plurality of lower surfaces 137B (recovery ports 132) capable of recovering the liquid LQ may be disposed in the periphery of the light path K (opening 120).

The second liquid immersion member 122 is a member different from the first liquid immersion member 121. The second liquid immersion member 122 is separated from the first liquid immersion member 121. The second liquid immersion member 122 is disposed in a portion of the periphery of the first liquid immersion member 121.

The second liquid immersion member 122 can form the liquid immersion space LS2 of the liquid LQ in at least a portion of the second space SP2 located below the second liquid immersion member 122. The second space SP2 is a space on the lower surface 124 side. The liquid immersion space LS2 is formed separated from the liquid immersion space LS1. The liquid immersion space LS2 is formed between the lower surface 124 and the upper surface of the substrate P (object). The liquid LQ can be held between the second liquid immersion member 122 and the substrate P (object). The liquid immersion space LS2 is formed by the liquid LQ held between the second liquid immersion member 122 and the substrate P. The liquid LQ is held between the lower surface 124 on one side and the upper surface of the substrate P (object) on the other side, and thus the liquid immersion space LS2 is formed.

In the present embodiment, at least a portion of an interface (a meniscus or an edge) LG2 of the liquid LQ of the liquid immersion space LS2 is formed between the lower surface 24 and the upper surface of the substrate P. The outer side (outer side of the interface LG2) of the liquid immersion space LS2 is a gas space.

The liquid immersion space LS2 is smaller than the liquid immersion space LS1. The size of the liquid immersion space includes the volume of liquid which forms the liquid immersion space. In addition, the size of the liquid immersion space includes the weight of liquid which forms the liquid immersion space. In addition, the size of the liquid immersion space includes, for example, the area of the liquid immersion space within the plane (XY plane) parallel to the surface (upper surface) of the substrate P. In addition, the size of the liquid immersion space includes, for example, the size of the liquid immersion space regarding a predetermined direction (for example, X-axis direction or Y-axis direction) within the plane (XY plane) parallel to the surface (upper surface) of the substrate P.

That is, within the plane (XY plane) parallel to the surface (upper surface) of the substrate P, the liquid immersion space LS2 is smaller than the liquid immersion space LS1. The volume (weight) of the liquid. LQ which forms the liquid immersion space LS2 is smaller than the volume (weight) of the liquid LQ which forms the liquid immersion space LS1. The size of the liquid immersion space LS2 within the XY plane is smaller than the size of the liquid immersion space LS1.

The liquid immersion space LS2 is smaller than the liquid immersion space LS1. Therefore, when the substrate P (object) moves in a state where the liquid immersion spaces LS1 and LS2 are formed, the movement (outflow) of a portion of the liquid LQ of the liquid immersion space LS2 to the outside of the second space SP2 separated from the liquid immersion space LS2 is suppressed. In other words, since the liquid immersion space LS2 is smaller than the liquid immersion space LS1, the outflow of a portion of the liquid LQ of the liquid immersion space LS2 from the second space SP2 is suppressed further than the outflow of a portion of the liquid LQ of the liquid immersion space LS1 from the first space SP1.

In the present embodiment, two second liquid immersion members 122 are disposed in the space around the first liquid immersion member 121. In the present embodiment, the second liquid immersion members 122 are disposed at one side (+X side) and the other side (−X side) of the first liquid, immersion member 121 in relation to the X-axis direction. The liquid immersion space LS2 is formed at one side (+X side) and the other side (−X side) of the liquid immersion space LS1 in relation to the X-axis direction.

Meanwhile, the second liquid immersion member 122 may be disposed at only one side (+X side) of the first liquid immersion member 121, and may be disposed at only the other side (−X side) thereof. The liquid immersion space LS2 may be disposed at only one side (+X side) of the liquid immersion space LS1, and may be disposed at only the other side (−X side) thereof.

In the present embodiment, at least a portion of the lower surface 124 is substantially parallel to the XY plane. Meanwhile, at least a portion of the lower surface 124 may be inclined toward the XY plane, and may include a curved surface.

In the present embodiment, the position (height) of the lower surface 123 and the position (height) of the lower surface 124 in relation to the Z-axis direction are substantially equal to each other. That is, the distance between the lower surface 123 and the upper surface of the substrate P (object) and the distance between the lower surface 124 and the upper surface of the substrate P (object) are substantially equal to each other.

Meanwhile, the lower surface 124 may be disposed at a position lower than that of the lower surface 123. That is, the distance between the lower surface 124 and the upper surface of the substrate P (object) may be smaller than the distance between the lower surface 123 and the upper surface of the substrate P (object). Meanwhile, the lower surface 124 may be disposed at a position higher than that of the lower surface 123. That is, the distance between the lower surface 124 and the upper surface of the substrate P (object) may be larger than the distance between the lower surface 123 and the upper surface of the substrate P (object).

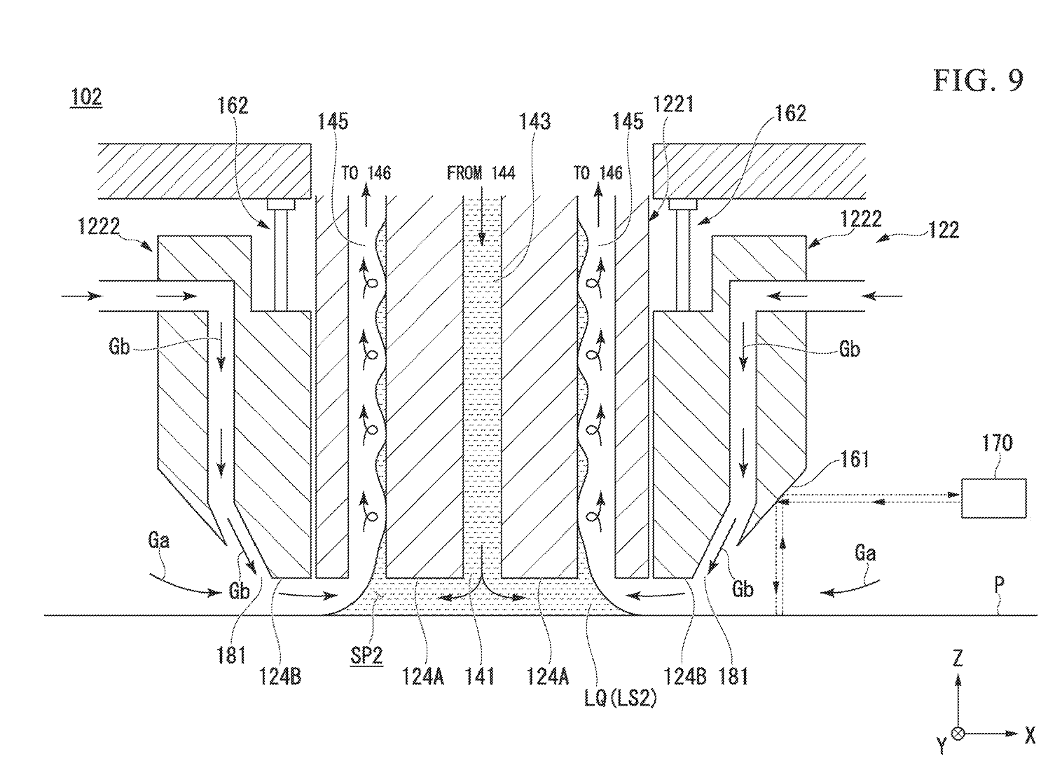

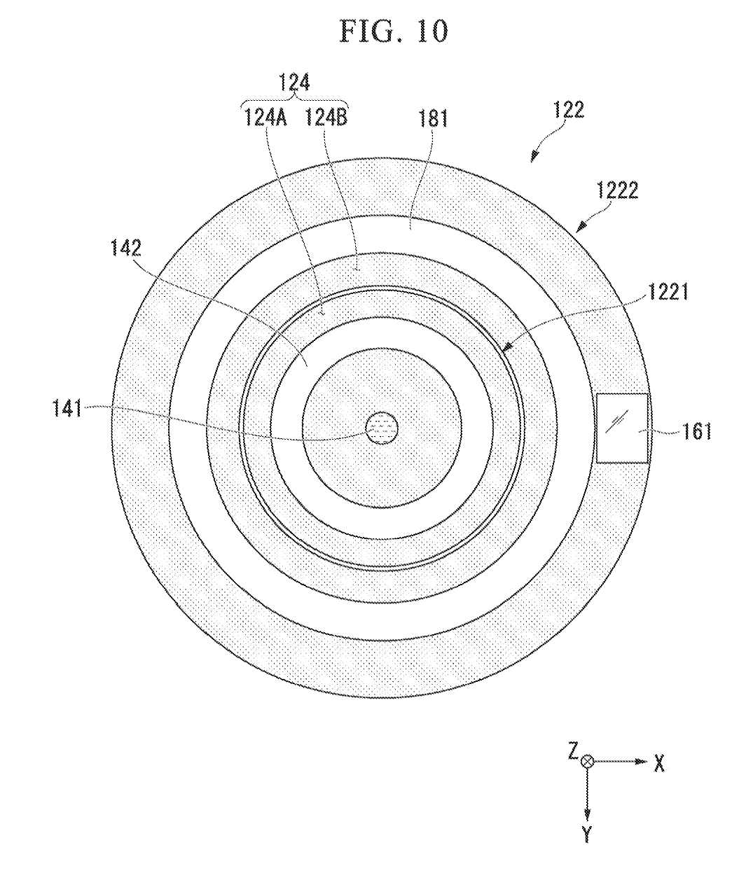

FIG. 9 is a cross-sectional view illustrating an example of the second liquid immersion member 122. FIG. 10 is a diagram when the second liquid immersion member 122 is viewed from the lower side (−Z side).

The second liquid immersion member 122 includes a first member 1221 having a first surface 124A that faces the upper surface of the substrate P (object with a first gap interposed therebetween and holds the liquid LQ between the upper surface of the substrate P (object) and the first surface, a second member 1222 which is disposed at the outside of the first surface 124A with respect to the center of the first surface 124A and has a second surface 124B facing the upper surface of the substrate P (object) with a second gap interposed therebetween, a gas supply port 181 that supplies the gas Gb having a higher viscosity than that of the gas Ga, and a suction port (recovery port) 142 which is disposed between the first surface 124A and the second surface 124B and suctions the gas Gb (gas Ga) through at least a portion of the second gap.

The second liquid immersion member 122 includes a supply port 141 that supplies the liquid LQ for forming the liquid immersion space LS2. The supply port 141 is disposed in the first member 1221. The supply port 141 is disposed in at least a portion of the lower surface 124 (first surface 124A). The supply port 141 is disposed at the center of the first surface 124A. The first surface 124A is disposed in the periphery of the supply port 141.

The recovery port (suction port) 142 recovers at least a portion of the liquid LQ of the liquid immersion space LS2. The recovery port 142 suctions the liquid LQ together with the gas Gb (Ga). The recovery port 142 is disposed in the first member 1221. The recovery port 142 is disposed so as to surround the supply port 141. In the present embodiment, the shape of the recovery port 142 within the XY plane is annular. Meanwhile, a plurality of recovery ports 142 may be disposed in the periphery of the supply port 141. That is a plurality of recovery ports 142 may be discretely disposed in the periphery of the supply port 141.

The supply port 141 is disposed so as to face the second space SP2 located below the second liquid immersion member 122. The substrate P (object) can face the supply port 141. The supply port 141 can supply the liquid LQ to the second space SP2.

In the present embodiment, the recovery port 142 is disposed so as to face the second space SP2 located below the second liquid immersion member 122. The substrate P (object) can face the recovery port 142. The recovery port 142 is disposed in at least a portion of the lower surface 124 (first surface 124A) of the second member 122. The recovery port 142 can recover at least a portion of the liquid LQ of the second space SP2. The recovery port 142 can recover gas of the second space SP2. In the present embodiment, the recovery port 142 recovers the liquid LQ together with the gas Gb (Ga). At least a portion of fluid (one or both of the liquid LQ and gas) of the second space SP2 is recovered from the recovery port 142.

The supply port 141 is connected to a liquid supply device 144 capable of supplying the liquid LQ through a supply flow channel 143 formed inside the first member 1221. The supply port 141 supplies the liquid LQ from the liquid supply device 144 to the second space SP2.

As shown in FIG. 7, in the present embodiment, the liquid, supply device 144 is connected to each of the second liquid immersion member 122 (first member 1221) on one side and the second liquid immersion member 122 (first member 1221) on the other side.

The recovery port 142 is connected to a liquid recovery device 146 capable of recovering (suctioning) the liquid LQ (gas) through a recovery flow channel 145 formed inside the first member 1221. The recovery port 142 can recover (suction) at least a portion of the liquid LQ of the second space SP2 between the second liquid immersion member 122 and the substrate P. The liquid LQ recovered from the second space SP2 located below the second liquid immersion member 122 flows in the recovery flow channel 145. The liquid LQ flowing from the recovery port 142 to the recovery flow channel 145 is recovered in a liquid recovery device 146. The liquid recovery device 146 can connect the recovery port 142 to the vacuum system BS.

The liquid recovery device 146 suctions the liquid LQ so that the pathway of the gas Gb (Ga) is maintained in the recovery flow channel 145.

As shown in FIG. 7, in the present embodiment, the liquid recovery device 146 is connected to each of the second liquid immersion member 122 (first member 1221) on one side and the second liquid immersion member 122 (first member 1221) on the other side.

In the present embodiment, the recovery of the liquid LQ from the recovery port 142 is performed concurrently with the supply of the liquid LQ from the supply port 141, and thus the liquid immersion space LS2 is formed by the liquid LQ between the second liquid immersion member 122 (first member 1221) on one side and the substrate P on the other side. The liquid immersion space LS2 is formed by the liquid LQ supplied from the supply port 141.

The gas supply port 181 is disposed at the outside of the second surface 124B with respect to the center (supply port 141) of the first surface 124A.

In the present embodiment, a driving device 162 capable of moving the second member 1222 is disposed. The driving device 162 can move the second member 1222 in at least the Z-axis direction. The driving device 162 can adjust the size of the second gap between the second surface 124B and the upper surface of the substrate P (object).

In the present embodiment, a detection device 170 that detects the size of the second gap is disposed. The detection device 170 irradiates a reflection surface of the reflection member 161 disposed in at least a portion of the second member 1222 with detection light. The detection light reflected from the reflection surface is incident on the upper surface of the substrate P (object). At least a portion of the detection light incident on the upper surface of the substrate P (object) is reflected from the upper surface of the substrate P (object), and is incident on the reflection surface of the reflection member 161. At least a portion of the detection light incident on the reflection surface of the reflection member 161 is reflected from the reflection surface thereof, and is incident on a light-receiving portion a the detection device 170. The detection device 170 can obtain the positional relationship (size of the second gap) between the second member 1222 and the substrate P in relation to the Z-axis direction, on the basis of the reception result of the detection light.

The driving device 162 moves the second member 1222 on the basis of the detection result of the detection device 170.

As described above, according to the present embodiment, the outflow of the liquid LQ of the liquid immersion space LS2 is suppressed.

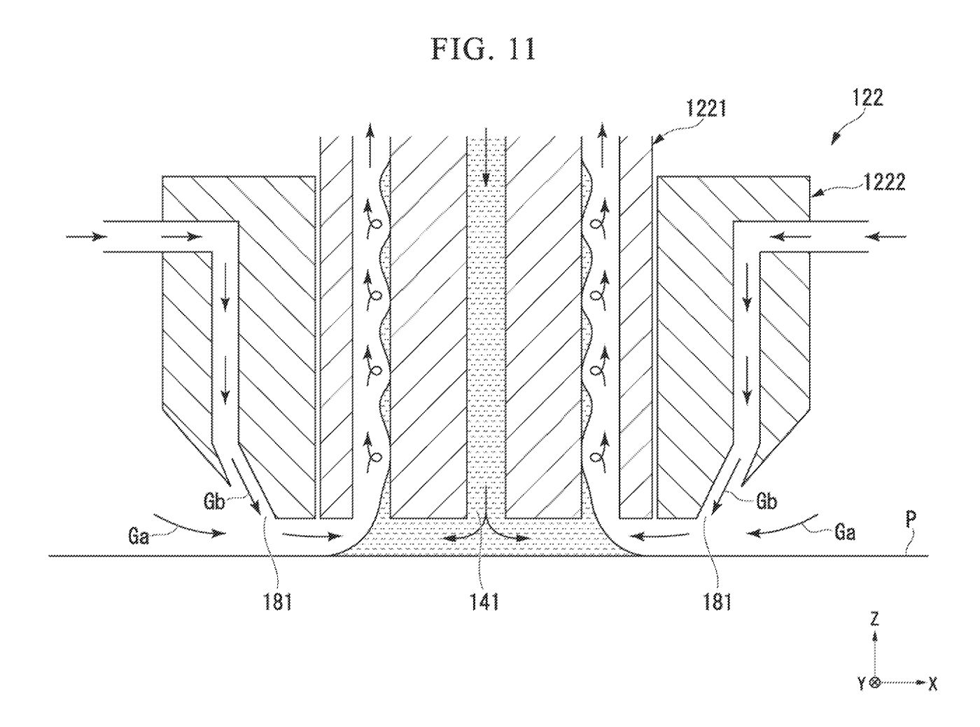

Meanwhile, as shown in FIG. 11, the driving device 162 ma be omitted. Meanwhile, the detection device 170 may be omitted.

Meanwhile, in the present embodiment, the second surface 124B may not be included. In addition, the second member 1222 may not be included. The gas Gb having a high viscosity is supplied to the periphery of the liquid immersion space LS2, so that the outflow of the liquid LQ of the liquid immersion space LS2 is suppressed.

Meanwhile, the gas Ga may be supplied from the gas supply port 181. The gas Ga is supplied from the gas supply port 181 of the second member 1222, so that the outflow of the liquid LQ of the liquid immersion space LS2 is also suppressed.

Meanwhile, in each of the above-mentioned embodiments, although the light path K on the emission side (image plane side) of the terminal optical element 12 of the projection optical system PL is filled with the liquid LQ, the projection optical system PL may be a projection optical system in which the light path on the incident side (object plane side) of the terminal optical element 12 is also filled with the liquid LQ, for example, as disclosed in Pamphlet of International Publication No. 2004/019,128.

Meanwhile, in each of the above-mentioned embodiments, although water is used as the liquid LQ for exposure, a liquid other than water may be used. It is preferable that the liquid LQ is transmissive to the exposure light EL, has a high refractive index with respect to the exposure light EL, and is stable with respect to a film such as a photosensitive material (photoresist) of which the projection optical system PL or the surface of the substrate P is formed. For example, fluorinated liquid such as hydrofluoroether (HFE), perfluorinated poly ether (PFPE), and Fomblin (registered trademark) oil can also be used as the liquid LQ. In addition, various fluids, for example, a supercritical fluid can also be used as the liquid LQ.

Meanwhile, as the substrate P of each of the above-mentioned embodiments, not only a semiconductor wafer for a semiconductor device, but also a glass substrate for a display device, a ceramic wafer for a thin-film magnetic head, or an original plate (synthetic silica, silicon wafer) of a mask or a reticle used in the exposure apparatus and the like may be applied.

The exposure apparatus EX can also be applied to a step-and-repeat type projection exposure apparatus (stepper) in which sequential step movement is performed on the substrate P by collectively exposing the patterns of the mask M in the state where the mask M and the substrate P are stopped, in addition to a step-and-scan type scanning exposure apparatus (scanning stepper) that scans and exposes the pattern of the mask M by synchronously moving the mask M and the substrate P.

Further, in the step-and-repeat type exposure, after a reduced image of a first pattern is transferred onto the substrate P using the projection optical system in the state where the first pattern and the substrate P are substantially stopped, a reduced image of a second pattern may be partially overlapped with the first pattern using the projection optical system to perform collective exposure onto the substrate P in the state where the second pattern and the substrate P are substantially stopped (stitch-type collective exposure apparatus). In addition, the stitch-type exposure apparatus can also be applied to a step-and-stitch type exposure apparatus which partially overlaps at least two patterns with each other on the substrate P to transfer them, and sequentially moves the substrate P.

In addition, for example, as disclosed in Specification of U.S. Pat. No. 6,611,316, the present invention can also be applied to an exposure apparatus which synthesizes patterns of two masks on the substrate through the projection optical system, and almost simultaneously double-exposes one shot region on the substrate by one-time scanning exposure. In addition, the present invention can also be applied to a proximity-type exposure apparatus, a mirror projection aligner and the like.

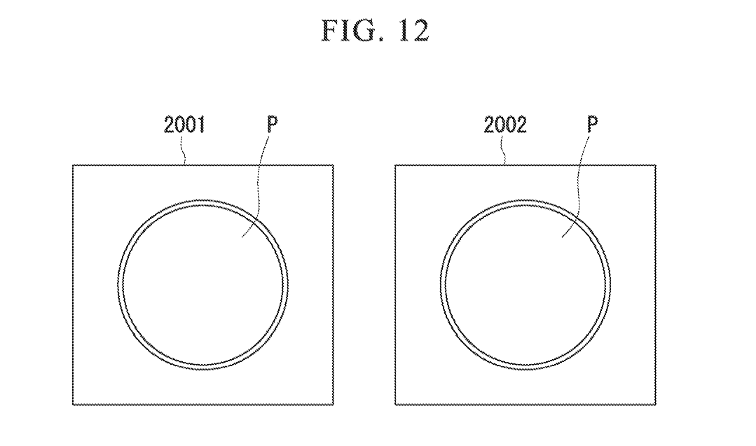

In addition, the present invention can also be applied to a twin stage type exposure apparatus which includes a plurality of substrate stages as disclosed in Specification of U.S. Pat. No. 6,341,007, Specification of U.S. Pat. No. 6,208,407, Specification of U.S. Pat. No. 6,262,796 and the like. For example, as shown in FIG. 12, When the exposure apparatus EX includes two substrate stages 2001 and 2002, the object capable of being disposed so as to face the emission surface 13 includes at least one of one substrate stage, a substrate held by the one substrate stage, the other substrate stage, and a substrate held by the other substrate stage.

In addition, the exposure apparatus can also be applied to an exposure apparatus including a plurality of substrate stages and measurement stages.

The type of exposure apparatus EX is also not limited to a semiconductor device fabrication exposure apparatus that exposes the pattern of a semiconductor device on the substrate P, but can be widely adapted to exposure apparatuses that are used for fabricating, for example, liquid crystal devices or displays, and exposure apparatuses that are used for manufacturing thin film magnetic heads, image capturing devices (CCDs), micro-machines, MEMS, DNA chips, reticles or masks, and the like.

Meanwhile, in the above-mentioned embodiments, an optically transmissive mask wherein a prescribed shielding pattern (or phase pattern or dimming pattern) is formed on an optically transmissive substrate is used; however, instead of such a mask, a variable shaped mask (also called an electronic mask, an active mask, or an image generator), wherein a transmissive pattern, a reflective pattern, or a light emitting pattern is formed based on electronic data of the pattern to be exposed, as disclosed in, for example, Specification of U.S. Pat. No. 6,778,257, may be used. In addition, instead of a variable shaped mask that includes a non-emissive type image display device, a pattern forming apparatus that includes a self-luminous type image display device may be provided.

In each of the above-mentioned embodiments, although the exposure apparatus that includes the projection optical system PL has been described by way of example, nevertheless the present invention can be applied to an exposure apparatus and an exposing method that do not use the projection optical system PL. For example, the immersion space can be formed between an optical member such as a lens and the substrate, and the substrate can be irradiated with the exposure light through the optical member.

In addition, the present invention can also be applied to an exposure apparatus (lithographic system) that, by forming interference fringes on the substrate P exposes the substrate P with a line-and-space pattern, as disclosed in, for example. Pamphlet of PCT International Publication No. WO2001/035,168.

The exposure apparatus EX according to the above-mentioned embodiments is manufactured by assembling various subsystems, including each of the components mentioned above, so that predetermined mechanical, electrical, and optical accuracies are maintained. To ensure these various accuracies, adjustments are performed before and after this assembly, including an adjustment to achieve optical accuracy for the various optical systems, an adjustment to achieve the mechanical accuracy for the various mechanical systems, and an adjustment to achieve the electrical accuracy for the various electrical systems. The process of assembling the exposure apparatus from the various subsystems includes, for example, the connection of mechanical components, the wiring and connection of electrical circuits, and the piping and connection of the pneumatic circuits among the various subsystems. Naturally, prior to performing the process of assembling the exposure apparatus from these various subsystems, there are also processes of assembling each individual subsystem. When the process of assembling the exposure apparatus from the various subsystems is complete, a comprehensive adjustment is performed to ensure the various accuracies of the exposure apparatus as a whole. Meanwhile, it is preferable to manufacture the exposure apparatus in a dean room in which, for example, the temperature and the cleanliness level are controlled.

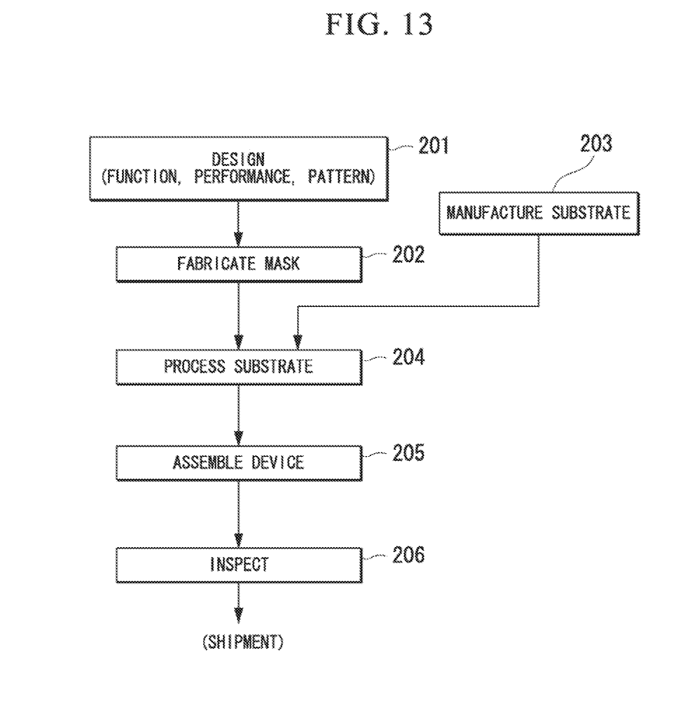

As shown in FIG. 13, a micro-device, such as a semiconductor device, is manufactured by a step 201 of designing the functions and performance of the micro-device, a step 202 of fabricating the mask (reticle) based on this designing step, a step 203 of manufacturing the substrate P which is the base material of the device, a substrate processing step 204 of a substrate process (exposure process) that includes, in accordance with the embodiments mentioned above, exposing the substrate P with the exposure light EL that is emitted from the pattern of the mask M and developing the exposed substrate P, a device assembling step 205 (which includes fabrication processes such as dicing, bonding, and packaging processes), an inspecting step 206 and the like.

Meanwhile, the features of each of the embodiments mentioned above can be combined as appropriate. In addition, there may be cases in which some of the components are not used. In addition, each disclosure of every Japanese published patent application and U.S. patent related to the exposure apparatus recited in each of the embodiments, modified examples, and the like discussed above is hereby incorporated by reference in its entirety to the extent permitted by national laws and regulations.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

1. An exposure apparatus that exposes a substrate to exposure light through liquid, comprising:
a first member which is disposed in at least a portion of the periphery of a light path of the exposure light, and has a first surface that faces an upper surface of an object via a first gap interposed therebetween and holds the liquid between the upper surface of the object and the first surface;
a second member which is disposed at the outside of the first surface with respect to the light path, and has a second surface that faces the upper surface of the object via a second gap interposed therebetween; and
a suction port which is disposed between the first surface and the second surface, and suctions at least a portion of gas in a space located outside the second member with respect to the light path, through the second gap,
wherein the size of the second gap is smaller than the size of the first gap.

2. The exposure apparatus according to claim 1, wherein the suction port is disposed so as to face the object, and
the size of a third gap between the suction port and the upper surface of the object is larger than the size of the second gap.

3. The exposure apparatus according to claim 1, further comprising a chamber device having an environmental control unit that supplies first gas to an internal space in which at least an optical member that emits the exposure light, the first member, and the second member are disposed,
wherein the suction port suctions the first gas from the environmental control unit.

4. The exposure apparatus according to claim 1, further comprising a supply port which is disposed at the outside of the second member with respect to the light path, and supplies second gas to the second gap,
wherein the suction port suctions the second gas from the supply port.

5. The exposure apparatus according to claim 1, further comprising:
a chamber device having an environmental control unit that supplies first gas to an internal space in which at least an optical member that emits the exposure light, the first member, and the second member are disposed; and
a supply port which is disposed at the outside of the second member with respect to the light path, and supplies second gas having a higher viscosity than viscosity of the first gas to the second gap,
wherein the suction port suctions the second gas from the supply port.

6. An exposure apparatus that exposes a substrate to exposure light through liquid, comprising:
a first member which is disposed in at least a portion of the periphery of a light path of the exposure light, and has a first surface that faces an upper surface of an object via a first gap interposed therebetween and holds the liquid between the upper surface of the object and the first surface;
a second member which is disposed at the outside of the first surface with respect to the light path, and has a second surface that faces the upper surface of the object via a second gap interposed therebetween;
a chamber device having an environmental control unit that supplies first gas to an internal space in which at least an optical member, the first member, and the second member are disposed;
a gas supply port that supplies second gas having a higher viscosity than viscosity of the first gas; and
a suction port which is disposed between the first surface and the second surface, and suctions the second gas through at least a portion of the second gap.

7. The exposure apparatus according to claim 6, wherein the gas supply port is disposed at the outside of the second member with respect to the light path.

8. The exposure apparatus according to claim 6, wherein the gas supply port is provided in the second surface.

9. The exposure apparatus according to claim 1, further comprising a driving device capable of moving the second member.

10. The exposure apparatus according to claim 9, wherein the driving device adjusts the size of the second gap.

11. The exposure apparatus according to claim 9, further comprising a detection device that detects the size of the second gap,
wherein the driving device moves the second member on the basis of a detection result of the detection device.

12. The exposure apparatus according to claim 11, wherein the second member includes a transparent member having the second surface, and
the detection device detects the size of the second gap through the transparent member.

13. The exposure apparatus according to claim 1, wherein the suction port is disposed in the first member.

14. The exposure apparatus according to claim 1, wherein the suction port suctions even at least a portion of the liquid.

15. The exposure apparatus according to claim 14, further comprising a fluid suction device which is connected to the suction port through a suction flow channel,
wherein the fluid suction device suctions the liquid so that a pathway of the gas is maintained in the suction flow channel.

16. An exposure apparatus that exposes a substrate to exposure light through first liquid of a first liquid immersion space, comprising:
an optical member having an emission surface from which the exposure light is emitted;
a first liquid immersion member which is disposed in at least a portion of the periphery of a light path of the exposure light, and folios the first liquid immersion space of the first liquid;
a second liquid immersion member which is disposed at the outside of the first liquid immersion member with respect to the light path, and is capable of forming a second liquid immersion space of second liquid, separated from the first liquid immersion space; and
a chamber device having an environmental control unit that supplies first gas to an internal space in which at least the optical member, the first liquid immersion member, and the second liquid immersion member are disposed,
wherein the second liquid immersion member includes
a first member having a first surface that faces an upper surface of an object via a first gap interposed therebetween and holds the liquid between the upper surface of the object and the first surface,
a second member which is disposed at the outside of the first surface with respect to the center of the first surface, and has a second surface that faces the upper surface of the object via a second gap interposed therebetween,
a gas supply port that supplies second gas having a higher viscosity than viscosity of the first gas, and
a suction port which is disposed between the first surface and the second surface, and suctions the second gas through at least a portion of the second gap.

17. The exposure apparatus according to claim 16, wherein the gas supply port is disposed at the outside of the second surface with respect to the center of the first surface.

18. The exposure apparatus according to claim 16, further comprising a driving device capable of moving the second member.

19. The exposure apparatus according to claim 18, wherein the driving device adjusts the size of the second gap.

20. The exposure apparatus according to claim 18, further comprising a detection device that detects the size of the second gap,
wherein the driving device moves the second member on the basis of a detection result of the detection device.

21. The exposure apparatus according to claim 16, wherein the suction port is disposed in the first member.

22. The exposure apparatus according to claim 16, wherein the suction port suctions even at least a portion of the liquid.

23. The exposure apparatus according to claim 22, further comprising a fluid suction device which is connected to the suction port through a suction flow channel,
wherein the fluid suction device suctions the liquid so that a pathway of the gas is maintained in the suction flow channel.

24. A device manufacturing method comprising:
exposing a substrate using the exposure apparatus according to claim 1; and
developing the exposed substrate.

25. A liquid holding method used in an exposure apparatus that exposes a substrate to exposure light through liquid on the substrate, comprising:
holding the liquid between a first surface of a first member disposed in at least a portion of the periphery of a light path of the exposure light and an upper surface of an object, the first surface facing the upper surface of the object via a first gap interposed therebetween; and
suctioning at least a portion of gas in a space located outside a second member with respect to the light path, through a second gap, from a suction port disposed between the first surface and a second surface of the second member disposed at the outside of the first surface with respect to the light path, the second surface facing the upper surface of the object via the second gap having a smaller size than the size of the first gap interposed therebetween.

26. A liquid holding method used in an exposure apparatus that exposes a substrate to exposure light through liquid on the substrate, comprising:
holding the liquid between a first surface of a first member disposed in at least a portion of the periphery of a light path of the exposure light and an upper surface of an object, the first surface facing the upper surface of the object via a first gap interposed therebetween;
suctioning at least a portion of gas in a space located outside a second member with respect to the light path, through a second gap, from a suction port disposed between the first surface and a second surface of the second member disposed at the outside of the first surface with respect to the light path, the second surface facing the upper surface of the object via the second gap interposed therebetween;
supplying first gas from an environmental control unit to an internal space in which at least an optical member, the first member, and the second member are disposed;
supplying second gas having a higher viscosity than viscosity of the first gas from a gas supply port; and
suctioning the second gas from the suction port disposed between the first surface and the second surface through at least a portion of the second gap.

27. A liquid holding method used in an exposure apparatus that exposes a substrate to exposure light through first liquid on the substrate, comprising:
holding second liquid between a first surface of a first member facing an upper surface of an object via a first gap interposed therebetween, and the upper surface of the object;
suctioning at least a portion of gas in a space located outside a second surface with respect to the center of the first surface, through a second gap, from a suction port disposed between the first surface and the second surface of a second member disposed at the outside of the first surface with respect to the center of the first surface, the second surface facing the upper surface of the object via the second gap interposed therebetween;
supplying first gas from an environmental control unit to an internal space in which at least an optical member, the first member, and the second member are disposed;
supplying second gas having a higher viscosity than viscosity of the first gas from a gas supply port; and
suctioning the second gas from the suction port disposed between the first surface and the second surface through at least a portion of the second gap.

28. A device manufacturing method comprising:
exposing a substrate through at least a portion of the liquid held by the liquid holding method according to claim 25; and
developing the exposed substrate.
